(19) United States
(12) Patent Application Publication
(10) Pub. No.: US 2026/0209972 A1
(43) Pub. Date: Jul. 23, 2026

(54) IMPROVED MULTI-LAYERED PROTON EXCHANGE MEMBRANE FOR WATER ELECTROLYSIS

(71) Applicants: W. L. Gore & Associates, Inc., Newark, DE (US); W. L. GORE & ASSOCIATES GMBH, Putzbrunn (DE)

(72) Inventors: John Gardner, Newark, DE (US); Amr Mahmoud Hamdy Kobaisy Ali, Putzbrunn (DE)

(73) Assignees: W. L. Gore & Associates, Inc., Newark, DE (US); W. L. GORE & ASSOCIATES GMBH, Putzbrunn (DE)

(21) Appl. No.: 19/138,954

(22) PCT Filed: Dec. 14, 2023
(86) PCT No.: PCT/EP2023/085957

§ 371 Date: Jun. 13, 2025

Related U.S. Application Data
(60) Provisional application No. 63/387,290, filed on Dec. 14, 2022.

(51) Int. Cl. C25B 13/08; C25B 1/04

(52) U.S. Cl. CPC C25B 13/08; C25B 1/04

(57) ABSTRACT

There is provided a multi-layered proton exchange membrane for water electrolysis, comprising: at least two recombination catalyst layers, each of the at least two recombination catalyst layers comprising a recombination catalyst and a first ion exchange material, wherein at least two recombination catalyst layers are separated by a region devoid of or substantially devoid of a recombination catalyst, and at least two reinforcing layers, each of the at least two reinforcing layers comprising a microporous polymer structure and a second ion exchange material which is at least partially imbibed within the microporous polymer structure.

### FIELD OF INVENTION

The present disclosure relates to a multi-layered proton exchange membrane for water electrolysis. The present disclosure also relates to a multi-layered proton exchange membrane electrode assembly, an electrolyzer comprising the multi-layered proton exchange membrane, use of the multi-layered proton exchange membrane in the electrolysis of water, and a method of manufacturing the multi-layered proton exchange membrane.

### BACKGROUND

Proton exchange membrane (PEM) water electrolysis is an important and very promising technology for the production of hydrogen. During PEM water electrolysis, electricity is employed to decompose water into oxygen and hydrogen gas. The hydrogen gas produced is an energy carrier and may be compressed, stored and used, for example, in a hydrogen fuel cell to generate electricity. The oxygen produced may be either released into the atmosphere or stored and used in industry or as a medical gas.

An electrolyzer is an electrochemical device in which PEM water electrolysis may occur. The electrolyzer comprises at least a PEM, an anode and a cathode. The PEM contains an ion exchange material which can conduct protons. The anode is typically a layer comprising iridium and the cathode is typically a layer comprising platinum. During electrolysis, the half reaction occurring at the anode is: 2H₂O→O₂+4H⁺+4 e⁻, and the half reaction occurring at the cathode is: 4H⁺+4 e⁻→2H₂. The H⁺ cations migrate from the anode to the cathode through the PEM to generate H₂ at the cathode.

In terms of sustainability and environmental impact, PEM water electrolysis is a promising technique for efficient hydrogen production since it emits only oxygen as a by-product, without any direct carbon emissions. Thus, lowering the production costs associated with PEM water electrolysis is desirable in order to achieve global decarbonization targets so that PEM water electrolysis can be employed more widely.

Techniques for lowering production costs associated with PEM water electrolysis include (i) improving the efficiency of PEM water electrolysis (ii) increasing the pressure of hydrogen to reduce downstream compression costs, and (iii) extending the range of electrolyzer operations to very low load range to maximise utilization of renewable energy sources, (iv) extending the operational lifetime of the electrolyzer and (v) decreasing capital and maintenance costs of hydrogen purification units by increasing purity level of produced hydrogen directly in the electrolysis cell, reducing the need of additional purification processes.

Improved efficiency of PEM water electrolysis may be achieved by reducing the thickness of the PEM and increasing the operating temperatures. Increasing the operating temperature may require enhanced chemical durability of the PEM to enable long lifetime. Increasing the pressure of hydrogen to reduce downstream compression likely requires increased mechanical strength of the PEM so that it may withstand the operating pressures.

However, many of these strategies to lower production costs by improving the efficiency of the PEM water electrolysis (by reducing the thickness of the PEM and using higher operating temperatures) and, increasing the hydrogen pressure, and operating at low load range both to reduce overall production costs, lead to increased “hydrogen crossover”. Hydrogen crossover refers to the concentration of hydrogen in the oxygen stream which has migrated from the cathode through the PEM to the anode. Hydrogen crossover contributes to degradation of the PEM, and leads to a safety concern if the concentration of hydrogen in the hydrogen-oxygen mixture at the anode exceeds the explosive limit of 4 mol %. Thus, during electrolysis, it is important to minimize hydrogen permeance through the PEM or to minimize the hydrogen concentration in the hydrogen-oxygen mixture so that the concentration of hydrogen in the hydrogen-oxygen mixture is not above 4 mol %. Safety standards generally dictate the hydrogen concentration should not exceed 2 mol %.

A known strategy to reduce the hydrogen concentration in the hydrogen-oxygen mixture is to employ a single recombination catalyst layer in or on the PEM. Additionally, a recombination catalyst layer in or on the PEM can reduce the oxygen concentration in the hydrogen-oxygen mixture. improving the purity of produced hydrogen. The recombination catalyst refers to a catalyst which recombines any permeated hydrogen crossing over from the cathode with oxygen in a controlled manner to form water, thereby reducing the amount of hydrogen entering the oxygen stream. Typically, the recombination catalyst layer is coated on one surface of the PEM which is positioned closest to the anode of the electrolyzer.

However, as thickness of the PEM decreases and the operating conditions become more aggressive (such as higher temperatures and pressures), the coating layer containing the recombination catalyst may not be thick enough to feasibly further increase the concentration of the recombination catalyst in this coating layer, in order to mitigate the increased hydrogen flux. Furthermore, increased recombination catalyst concentration near the anode side of PEM may lead to unfavourable processes that can chemically attack the PEM and the electrodes, reducing the lifetime of the electrolyzer, especially at higher operating temperatures. For example, a high concentration of recombination catalyst near the anode may lead to peroxide generation which can create radicals which in turn degrade the ion exchange material of the PEM. Additionally, as thickness of PEM decreases, the coating layer containing the recombination catalyst may not be optimally positioned to also reduce the crossed over oxygen to ensure purity of produced hydrogen.

The problem of excessive hydrogen crossover can be exacerbated due to damage or punctures in the PEM caused by using aggressive operating conditions or electrolyzer fabrication, especially when the membrane is relatively thin. A strategy to improve resistance to damage or punctures is to include a single reinforcing layer in the PEM. The reinforcing layer may be a microporous polymer structure imbibed with an ion exchange material and it is therefore conductive to ions. However, even PEMs reinforced in this manner can be subject to damage or punctures during electrolyzer operation and fabrication.

Thus, there is a need for improved multi-layer proton exchange membranes for water electrolysis which allow for production costs to be reduced. That is, there is a need for improved multi-layer proton exchange membranes which withstand aggressive operating conditions such as high temperatures and pressures, are relatively thin, and limit unfavourable chemical processes near the anode side of the membrane, while mitigating the increased hydrogen and oxygen flux so that the hydrogen concentration in the oxygen stream is acceptably low and the produced hydrogen has the desired purity level.

The present disclosure addresses the problems mentioned above.

### SUMMARY

In a first aspect, there is provided a multi-layered proton exchange membrane (herein a “PEM”) for water electrolysis, comprising: (i) at least two recombination catalyst layers, each of the at least two recombination catalyst layers comprising a recombination catalyst and a first ion exchange material, wherein at least two recombination catalyst layers are separated by a region devoid of or substantially devoid of a recombination catalyst, and (ii) at least two reinforcing layers, each of the at least two reinforcing layers comprising a microporous polymer structure and a second ion exchange material which is at least partially imbibed within the microporous polymer structure.

The PEM comprising at least two recombination catalyst layers is effective to reduce the hydrogen concentration in the oxygen stream to acceptably low concentrations, while limiting unfavourable chemical processes by optimizing recombination catalyst concentrations and layer locations, particularly for a low proton, low hydrogen and/or oxygen resistance multilayer reinforced PEM used in an electrolyzer. Specifically, the at least two recombination catalyst layers in a low proton, low hydrogen and/or low oxygen resistance multilayer reinforced PEM can alleviate processing and performance limitations when compared to one recombination catalyst layer in cases where high concentration of the recombination catalyst are required.

Specifically, having at least two recombination catalyst layers may allow for the PEM to contain a higher total amount of recombination catalyst compared to employing a single recombination catalyst layer, because it is not always practically feasible to sufficiently increase the recombination catalyst concentration in a single layer in order to reduce the hydrogen concentration in the oxygen stream and/or the oxygen concentrations in the hydrogen stream to acceptably low concentrations.

Furthermore, at least two recombination catalyst layers being separated by a region devoid of or substantially devoid of a recombination catalyst allows the recombination catalyst in the PEM to be located in different positions in the PEM, instead of being located in a single position in the PEM. Typically, the recombination catalyst is located on one surface of the PEM, which is typically placed next to the anode in an electrolyzer. Depending on the design and assembly of the stack, electrodes, and PEM, and the operating pressures and temperature, the most optimum position of the recombination catalyst to maximize effective recombination may not be near the anode surface. This optimum position within the PEM may also change over time for instance as the effect of hydrogen supersaturation changes with degradation of cell components. Having recombination catalyst at the anode side of the PEM may lead to unfavourable processes that can chemically attack the PEM and the electrodes, reducing the lifetime of the electrolyzer, especially at higher operating temperatures. Thus, by locating the recombination catalyst in different positions in the PEM, instead of in a single position, there can be recombination catalyst located in a broader regime of the PEM thickness. This could enable higher recombination effectiveness at a broader set of stack designs and assembly techniques as well as at different operating pressures and temperatures. Importantly, as the system degrades over time, the broader distribution of recombination catalyst through the PEM thickness could enable maintaining effective recombination over time as the system degrades for instance if the degree of supersaturation changes. Some of the recombination catalyst can be located further away from the anode of an electrolyzer, thereby limiting the unfavourable processes that could occur near the anode side in the PEM. This would then improve the lifetime of the PEM and electrolyzer. For example, some of the recombination catalyst may be located more towards the cathode.

The PEM comprising at least two reinforcing layers provides mechanical strength to the PEM, allowing the thickness of the PEM to be reduced, thereby increasing the efficiency of electrolysis. The at least two reinforcing layers also allow more aggressive operating conditions to be used, such as higher temperature and pressures, thereby increasing the efficiency of electrolysis and saving costs.

Moreover, the PEM comprising at least two reinforcing layers helps to avoid damage and punctures in the PEM caused by using aggressive operating conditions or electrolyzer fabrication, especially when the membrane is relatively thin. This helps to further extend the lifetime of the PEM and to reduce hydrogen and oxygen crossover, which can occur to a greater extent if the PEM is damaged or punctured.

Thus, the PEM of the present disclosure allows for production costs to be reduced during electrolysis. That is, the PEM of the present disclosure may withstand aggressive operating conditions such as relatively high temperatures and pressures, may be relatively thin, and may limit unfavourable chemical processes near the anode side of the membrane, while mitigating the increased hydrogen flux so that the hydrogen concentration in the oxygen stream is acceptably low and/or while mitigating the increased oxygen flux so that the oxygen concentration in the hydrogen stream is acceptably low.

In one embodiment, the region separating at least two recombination catalyst layers may have a thickness d, of at least about 1 μm at 50% RH (relative humidity). The region separating the recombination catalyst layers may have a thickness d, at 50% RH of at least about 2 μm, or at least about 3 μm, or at least about 4 μm, or at least about 5 μm, or at least 10 μm, or at least 20 μm, or at least 30 μm, or at least 40 μm, or at least 50 μm, or at least 60 μm, or at least 70 μm, or at least 80 μm.

In one embodiment, the at least two recombination catalyst layers may be separated by a region having a thickness d, wherein the thickness d is from about 1 μm to about 80 μm at 50% RH. The region may have a thickness, d from about 1 μm to about 70 μm, or from about 1 μm to about 60 μm, or from about 1 μm to about 50 μm, or from about 1 μm to about 40 μm, or from about 1 μm to about 30 μm, or from about 1 μm to about 20 μm, or from about 1 μm to about 12 μm, at 50% RH. The region may have a thickness, d from about 2 μm to about 80 μm, or from about 2 μm to about 60 μm, or from about 2 μm to about 50 μm, or from about 2 μm to about 40 μm, or from about 2 μm to about 30 μm, or from about 2 μm to about 20 μm, or from about 2 μm to about 12 μm, at 50% RH. The region may have a thickness, d from about 5 μm to about 80 μm, or from about 5 μm to about 60 μm, or from about 5 μm to about 50 μm, or from about 5 μm to about 40 μm, or from about 5 μm to about 30 μm, or from about 5 μm to about 20 μm, or from about 5 μm to about 12 μm, at 50% RH. The region may have a thickness, d from about 10 μm to about 80 μm, or from about 10 μm to about 60 μm, or from about 10 μm to about 50 μm, or from about 10 μm to about 40 μm, or from about 10 μm to about 30 μm, or from about 10 μm to about 20 μm, at 50% RH.

In one embodiment, the region separating at least two recombination catalyst layers may comprise at least one layer devoid of or substantially devoid of a recombination catalyst. The at least one layer devoid of or substantially devoid of a recombination catalyst may comprise at least one reinforcing layer or at least one ion exchange material layer or combinations thereof. The region may comprise more than one layer, such as two or three layers.

In one embodiment, the recombination catalyst may comprise one or more selected from platinum, palladium, iridium, rhodium, ruthenium, osmium, nickel, cobalt, titanium, tin, tantalum, niobium, antimony, lead, manganese, and an oxide thereof. The recombination catalyst may comprise at least one platinum group metal selected from platinum, palladium, iridium, rhodium, ruthenium and osmium. The recombination catalyst may comprise at least one alloy of the platinum group metal or at least one mixed oxide of the platinum group metal with other metals such as cerium and titanium. The recombination catalyst may be present on a support material, and the support material may be a carbon particulate such as carbon black. In one embodiment, the recombination catalyst is platinum supported on a carbon particulate.

The recombination catalyst in each of the at least two recombination catalyst layers may be the same or different. In one embodiment, the recombination catalyst in each of the at least two recombination catalyst layers is the same. In another embodiment, the recombination catalyst in each of the at least two recombination catalyst layers is different.

The recombination catalyst in each of the at least two recombination catalyst layers may comprise one or more recombination catalyst species.

In one embodiment, each of the at least two recombination catalyst layers may have a minimum thickness at 50% RH of about 1 μm, or a thickness in the range of from about 1 μm to about 35 μm, or in the range of from about 1 μm to about 20 μm, or in the range of from about 5 μm to about 35 μm, or in the range of from about 5 μm to about 20 μm, or in the range of from about 3 μm to about 15 μm, or a thickness in the range of from about 4 μm to about 12 μm, or a thickness in the range of from about 3 μm to about 8 μm.

In one embodiment, the recombination catalyst may be present in each of the at least two recombination catalyst layers at a loading of up to about 0.10 mg/cm², or at a loading in the range of from about 0.001 mg/cm² to about 0.10 mg/cm², or at a loading range of from about 0.001 mg/cm² to about 0.09 mg/cm², or at a loading in the range of from about 0.008 mg/cm² to about 0.025 mg/cm².

In one embodiment, at least one recombination catalyst layer may comprise one or more additives selected from an anti-oxidant and a radical scavenger.

In one embodiment, the PEM may comprise a total of two recombination catalyst layers. In another embodiment, the PEM may comprise a total of three recombination catalyst layers. In another embodiment, the PEM may comprise a total of four recombination catalyst layers.

In one embodiment, the recombination catalyst of each of the at least two recombination catalyst layers may be dispersed in the first ion exchange material. The recombination catalyst may be substantially uniformly dispersed in the first ion exchange material. In some examples, there may be two recombination catalysts, each of which may be dispersed in first ion exchange materials, and wherein each of the two recombination catalysts may be the same or different recombination catalysts, and each of the two first ion exchange materials may be the same or different first ion exchange materials.

In one embodiment, the PEM may comprise an ion exchange material layer comprising a third ion exchange material, wherein the ion exchange material layer is devoid of or substantially devoid of a microporous polymer structure and a recombination catalyst. The region separating at least two recombination catalyst layers may comprise the ion exchange material layer.

In one embodiment, the first ion exchange material, the second ion exchange material and the third ion exchange material may be the same or different. In one embodiment, the first ion exchange material and the second ion exchange material may be the same. The first ion exchange material, the second ion exchange material and the third ion exchange material may be the same. In one embodiment, the first ion exchange material and the second ion exchange material may be different. The first ion exchange material and the second ion exchange material may be the same, and the at least two recombination catalyst layers and the at least two reinforcing layers may be formed with ion exchange material from the same ion exchange material dispersion.

In one embodiment, the first ion exchange material, the second ion exchange material and the third ion exchange material may each comprise at least one ionomer. The at least one ionomer may comprise a proton conducting polymer. The proton conducting polymer may be selected from a hydrocarbon ionomer, a perfluorinated ionomer and perfluorosulfonic acid ionomer.

In one embodiment, the region separating at least two recombination catalyst layers may comprise at least one reinforcing layer.

In one embodiment, the second ion exchange material which is at least partially imbibed within the microporous polymer structure may render the microporous polymer structure occlusive.

In one embodiment, the microporous polymer structure may be fully or substantially fully imbibed with the second ion exchange material.

In one embodiment, the total content of the microporous polymer structure in the PEM may be at least about 1 g/m² based upon the total area of the PEM.

In one embodiment, each of the at least two reinforcing layers may have a microporous polymer structure content of at least about 1 g/m² based upon the total area of the PEM.

In one embodiment, the microporous polymer structure of each of the at least two reinforcing layers may comprise at least one fluorinated polymer. The fluorinated polymer may be selected from polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) and mixtures thereof. The fluorinated polymer may be expanded polytetrafluoroethylene (ePTFE).

In one embodiment, the microporous polymer structure of each of the at least two reinforcing layers may comprise a hydrocarbon polymer. The hydrocarbon polymer may be selected from polyethylene, polypropylene, polycarbonate, polystyrene, polysulfone, polyethersulfone, polyethylene naphthalate and mixtures thereof.

In one embodiment, each of the at least two reinforcing layers may be devoid of or substantially devoid of a recombination catalyst.

In one embodiment, the PEM may have a total thickness at 50% RH (relative humidity) of from about 20 μm to about 250 μm, or from about 20 μm to about 200 μm, or from about 20 μm to about 150 μm, or from about 20 μm to about 120 μm, or from about 20 μm to about 100 μm, or from about 20 μm to about 90 μm, or from about 20 μm to about 80 μm, or from about 20 μm to about 70 μm, or from about 20 μm to about 60 μm, or from about 20 μm to 50 μm, or from about 20 μm to 45 μm.

### In One Embodiment, the PEM May Comprise at Least the Following Layers in the Order:

(i) a recombination catalyst layer;
(ii) a reinforcing layer;
(iii) a recombination catalyst layer;
(iv) a reinforcing layer,
   wherein the reinforcing layers are devoid of or substantially devoid of a recombination catalyst, and the recombination catalyst layers are devoid of or substantially devoid of a microporous polymer structure. The PEM may further comprise (v) an ion exchange material layer, in contact with the reinforcing layer (iv), wherein the ion exchange material layer is devoid of or substantially devoid of a microporous polymer structure and a recombination catalyst. In one embodiment the recombination catalyst layer (i) is intended, in use, to be at or closest to the anode of an electrolyser PEM electrode assembly. In another embodiment, an ion exchange material layer may be provided adjacent to the recombination catalyst layer (i) such that the ion exchange material layer forms an outer surface layer on the PEM.

### In Another Embodiment, the PEM May Comprise at Least the Following Layers in the Order:

(i) an ion exchange material layer;
(ii) a recombination catalyst layer;
(iii) a reinforcing layer;
(iv) an ion exchange material layer;
(v) a reinforcing layer;
(vi) a recombination catalyst layer;
(vii) an ion exchange material layer;
   wherein a layer of ion exchange material is provided at two surfaces of the PEM, adjacent to the recombination catalyst layers.

### In Another Embodiment, the PEM May Comprise at Least the Following Layers in the Order:

(i) a reinforcing layer
(ii) a recombination catalyst layer;
(iii) an ion exchange material layer;
(iv) a recombination catalyst layer;
(v) a reinforcing layer,
   wherein the reinforcing layers are devoid of or substantially devoid of a recombination catalyst, the recombination catalyst layers are devoid of or substantially devoid of a microporous polymer structure, and the ion exchange material layer is devoid of or substantially devoid of a microporous polymer structure and a recombination catalyst. In one embodiment the reinforcing layer (i) or (v) is intended, in use, to be at or closest to the anode of an electrolyser PEM electrode assembly. The PEM may further comprise additional recombination catalyst layers, reinforcing layers and ion exchange material layers. For example, the PEM may comprise an additional ion exchange material layers at the outer surfaces such that the PEM may comprise at least the following layers in the order:
(i) an ion exchange material layer;
(ii) a reinforcing layer;
(iii) a recombination catalyst layer;
(iv) an ion exchange material layer;
(v) a recombination catalyst layer;
(vi) a reinforcing layer;
(vii) an ion exchange material layer.

The PEM may further comprise additional reinforcing layers, for example, adjacent to the recombination catalyst layers such that the PEM may comprise at least the following layers in the order:
(i) an ion exchange material layer;
(ii) a reinforcing layer;
(iii) a recombination catalyst layer;
(iv) a reinforcing layer;
(iv) an ion exchange material layer;
(v) a reinforcing layer;
(vi) a recombination catalyst layer;
(viii) a reinforcing layer;
(viii) an ion exchange material layer.

In one embodiment, a recombination catalyst layer may be configured to be in contact with an anode of a PEM electrode assembly. A recombination catalyst layer may be configured to be in contact with a cathode of a PEM electrode assembly.

In another aspect, there is provided a multi-layered proton exchange membrane electrode assembly, comprising: at least one electrode; and the PEM of the present disclosure in contact with the at least one electrode.

In one embodiment, the PEM may be attached to the at least one electrode. The electrode may comprise a porous layer. The electrode may comprise carbon fibers, and optionally wherein the carbon fibers have a diameter from about 5 to about 30 μm.

In one embodiment, the PEM electrode assembly may further comprise a fluid diffusion layer selected from a felt, a paper, a woven material, a carbon/carbon based diffusion layer, metal mesh, or metallic mesh, titanium porous sintered powder mesh, a stainless steel mesh and mixtures thereof.

In one embodiment, the PEM electrode assembly may comprise a first electrode and a second electrode, optionally wherein the first electrode is an anode and the second electrode is a cathode. The anode may be in contact with a recombination catalyst layer. The cathode may in contact with a recombination catalyst layer. In another embodiment, the cathode may be in contact with another recombination catalyst layer.

In another aspect, there is provided an electrolyzer comprising the PEM of the present disclosure or the PEM electrode assembly of the present disclosure.

In another aspect, there is provided a use of the PEM of the present disclosure in the electrolysis of water.

In another aspect, there is provided a method of manufacturing a multi-layered proton exchange membrane of the present disclosure, the method comprising the step of:
forming at least two reinforcing layers, at least two recombination catalyst layers, and optionally one or more further layers, in any order, with the proviso that the resulting PEM comprises at least two recombination catalyst layers which are separated by a region devoid of or substantially devoid of a recombination catalyst.

The method of manufacturing may comprise forming the PEM in a sequential process, wherein each layer of the PEM is sequentially deposited in a depositing step in a desired order. In embodiments the PEM may be formed onto a backer layer or another layer. The depositing step may comprise at least one of coating, positioning or forming. The method may comprise forming two or more layers in a single depositing step. The method may comprise a drying step in between a depositing step and/or in between a plurality of depositing steps. The drying step may comprise heating or any other suitable drying process.

The method may comprise forming an ion exchange material layer by depositing a dispersion of ion exchange material onto a backer layer or another layer of the PEM, for example, a microporous polymer structure. In some examples, no backer layer is provided. The ion exchange material may be the first, second or third ion exchange material.

The method may comprise forming a recombination catalyst layer by depositing a dispersion comprising ion exchange material and recombination catalyst material onto a backer layer, and/or another layer of the PEM, for example, a microporous polymer structure.

The method of manufacture may comprise forming a recombination catalyst layer by depositing a dispersion comprising ion exchange material and recombination catalyst onto reinforcing layer comprising a microporous polymer structure. The recombination catalyst particles or aggregates of recombination catalyst particles in the dispersion may be larger than the pore size of the microporous polymer structure and may be unable to imbibe into the microporous polymer structure. This method step may allow for at least a portion of the region devoid of, or substantially devoid of recombination catalyst to be formed.

The method of manufacture may comprise using the microporous structure to filter out recombination catalyst from the dispersion of ion exchange material and recombination catalyst to form a recombination catalyst layer on an surface of the reinforcing layer. The microporous polymer structure may be configured to prevent recombination catalyst particles or aggregates from impregnating into the pores of the microporous polymer structure.

The method may comprise the recombination catalyst not imbibing into the reinforcing layer, thus forming the recombination catalyst layer on a surface of the reinforcing layer.

The method may comprise forming at least one of the at least two recombination catalyst layers by depositing a microporous polymer structure on to a dispersion comprising ion exchange material and recombination catalyst particles or aggregates, and wherein the microporous polymer structure is configured to prevent recombination catalyst particles or aggregates from impregnating into the pores of the microporous polymer structure.

The method may comprise imbibing the microporous polymer structure with the ion exchange material from the dispersion of ion exchange material and recombination catalyst, thereby forming a reinforcing layer, wherein the microporous polymer structure is configured such that the recombination catalyst cannot impregnate into the pores of the microporous polymer structure. The method may comprise forming a recombination catalyst layer and a reinforcing layer in a single step from the same dispersion comprising ion exchange material and recombination catalyst. The ion exchange material may the first, second or third ion exchange material as set out in the present disclosure. The reinforcing layer formed as such may be devoid or, or substantially devoid of recombination catalyst.

The method may comprise forming a reinforcing layer by depositing a dispersion comprising ion exchange material onto a microporous polymer structure.

The method may comprise forming an ion exchange material layer and adjacent reinforcing layer in one step, wherein the ion exchange material layer is formed by a layer of dispersion of ion exchange material which has not imbibed into the microporous polymer structure forming the reinforcing layer.

The method of manufacturing the PEM may also include, for example, coating a surface of a tensioned microporous polymer structure and allowing the dispersion to at least partially imbibe. The method may comprise performing sequential coatings by either depositing a further microporous polymer structure and then coating the top surface of the microporous polymer structure or depositing further liquid dispersions. The method of manufacture may comprise dip coating a microporous polymer structure in a bath of dispersion and, for example, either drying or laying on a backer layer and then drying or applying subsequent coatings.

The foregoing aspects and embodiments should not be read to limit or otherwise narrow the scope of any of the inventive concepts otherwise provided by the present disclosure. While multiple embodiments are disclosed, other embodiments will become apparent to those skilled in the art from the following description and drawings. Accordingly, the description and drawings are to be regarded as illustrative rather than restrictive.

### BRIEF DESCRIPTION OF THE FIGURES

FIGS. 1A-G show schematic representations of PEMs according to the present disclosure.

FIG. 2 shows a cross-sectional SEM (scanning electron microscope image) of the PEM of Example 1 and FIG. 1C.

FIG. 3 shows a cross-sectional back-scattered image of the PEM of Example land FIG. 1C.

FIGS. 4A-4E show schematic representations of PEMs according to embodiments of the present disclosure.

FIG. 5A shows a cross-section SEM of the PEM of Example 3, and FIG. 4A.

FIG. 5B shoes a cross-sectional back-scattered image of the PEM of Example 3 and FIG. 4A.

FIGS. 6A-6B show schematic representations of PEM as comparative examples for the present disclosure.

FIG. 6C shows a cross-sectional SEM of the PEM of FIG. 6B (comparative example 2).

FIG. 6D shoes a cross-sectional back-scattered image of the PEM of FIG. 6B (comparative example 2).

FIG. 7 shows a schematic of a method of producing a PEM according to the present disclosure.

FIG. 8 shows a schematic of a PEM electrode assembly according to the present disclosure.

FIG. 9A shows plot of hydrogen crossover according to electric current density for PEMs according to the present disclosure and comparative examples, when in use in an electrolyzer.

FIG. 9B shows chart of hydrogen crossover according to electric current density for PEMs according to the present disclosure and comparative examples, when in use in an electrolyzer.

FIG. 9C shows a chart of oxygen crossover of the PEM of Example 3 and comparative Example 2 measured at an electric current density of 3 A/cm².

It should be noted that the accompanying figures referred to herein are not necessarily drawn to scale but may be exaggerated to illustrate various aspects of the present disclosure, and in that regard, the figures should not be construed as limiting.

### DETAILED DESCRIPTION

The present disclosure provides a multi-layered proton exchange membrane (referred to herein as “PEM”) for water electrolysis, comprising: at least two recombination catalyst layers, each of the at least two recombination catalyst layers comprising a recombination catalyst and a first ion exchange material, wherein the at least two recombination catalyst layers are separated by a region devoid of or substantially devoid of a recombination catalyst, and at least two reinforcing layers, each of the at least two reinforcing layers comprising a microporous polymer structure and a second ion exchange material which is at least partially imbibed within the microporous polymer structure.

The present inventors have surprisingly discovered that a PEM comprising at least two recombination catalyst layers is effective to reduce the hydrogen concentration in the oxygen stream to acceptably low concentrations, while limiting unfavourable chemical processes by optimizing recombination catalyst concentrations and layer locations, particularly for a low proton and low hydrogen resistance multilayer reinforced PEM used in an electrolyzer. In addition, a PEM comprising at least two recombination catalyst layers is also effective to reduce the oxygen concentration in the hydrogen stream to acceptable low concentrations by optimizing recombination catalyst concentrations and layer locations. Specifically, the at least two recombination catalyst layers in low proton and low hydrogen resistance multilayer reinforced PEM can alleviate processing limitations when compared to one recombination catalyst layer in cases where high concentration of the recombination catalyst are required.

Having at least two recombination catalyst layers may allow for the PEM to contain a higher total amount of recombination catalyst compared to employing a single recombination catalyst layer, because it is not always practically feasible to sufficiently increase the recombination catalyst concentration in a single layer in order to reduce the hydrogen concentration in the oxygen stream to acceptably low concentrations and/or to reduce the oxygen concentration in the hydrogen stream to acceptable low concentrations.

Furthermore, at least two recombination catalyst layers being separated by a region devoid of or substantially devoid of a recombination catalyst allows the recombination catalyst in the PEM to be located in different positions or layers in the PEM, instead of being located in a single position or layer in the PEM. Typically, in state of the art membranes, the recombination catalyst is located on one surface of the PEM, which is typically placed next to the anode in an electrolyzer. However, having high amounts of recombination catalyst at the anode side of PEM may lead to unfavourable processes that can chemically attack the PEM and the electrodes, reducing the lifetime of the electrolyzer, especially at higher operating temperatures. Thus, by locating the recombination catalyst in different positions or layers in the PEM, instead of in a single position or layer, some of the recombination catalyst can be located further away from the anode of an electrolyzer, thereby limiting the unfavourable processes that occur near the anode side in the PEM, without significantly affecting the amount of hydrogen crossover. This improves the lifetime of the PEM and electrolyzer.

The PEM comprising at least two reinforcing layers provides mechanical strength to the PEM, allowing the thickness of the PEM to be reduced, thereby increasing the efficiency of electrolysis. The at least two reinforcing layers also allow more aggressive operating conditions to be used, such as higher temperature and pressures, thereby increasing the efficiency of electrolysis and saving costs.

Moreover, the PEM comprising at least two reinforcing layers helps to avoid damage and punctures in the PEM caused by using aggressive operating conditions or electrolyzer fabrication, especially when the membrane is relatively thin. This helps to further extend the lifetime of the PEM and to reduce hydrogen crossover, which can occur to a greater extent if the PEM is damaged or punctured. In particular, for a given total content of microporous polymer structure and thickness of the PEM at 50% RH, distributing the total content of the microporous polymer structure between two or more reinforcing layers increases the resistance to piercing of the PEM by electrolyzer components upon electrolyzer fabrication compared to PEMs having the same content of reinforcement material in a single reinforcing layer.

As outlined above, depending on the design and assembly of the stack, electrodes, and PEM, and the operating pressures and temperature, the most optimum position of the recombination catalyst to maximize effective may not be near the anode surface. This optimum position within the PEM may also change over time for instance as the effect of hydrogen supersaturation changes with degradation of cell components. Thus, by locating the recombination catalyst in different positions in the PEM, instead of in a single position, there can be recombination catalyst located in a broader regime of the PEM thickness. This could enable higher recombination effectiveness at a broader set of stack designs and assembly techniques as well as at different operating pressures and temperatures. Importantly, as the system degrades over time, the broader distribution of recombination catalyst through the PEM thickness can enable maintaining effective recombination over time as the system degrades for instance if the degree of supersaturation changes. Some of the recombination catalyst can be located further away from the anode of an electrolyzer, thereby limiting the unfavourable processes that could occur near the anode side in the PEM. This would then improve the lifetime of the PEM and electrolyzer.

Thus, the PEM of the present disclosure allows for production costs to be reduced for water electrolysis. That is, the PEM of the present disclosure may withstand aggressive operating conditions such as relatively high temperatures and pressures, may be relatively thin, and may limit unfavourable chemical processes near the anode side of the membrane, while mitigating the increased hydrogen flux so that the hydrogen concentration in the oxygen stream is acceptably low as well as mitigation the increased oxygen flux to that the oxygen concentration in the hydrogen stream is acceptable low.

### [Recombination Catalyst Layer]

The PEM comprises at least two recombination catalyst layers. Each of the recombination catalyst layers comprises recombination catalyst and a first ion exchange material.

The recombination catalyst is a catalyst capable of catalysing the reaction between molecular hydrogen (H₂) and molecular oxygen (O₂) to produce water (H₂O) and/or to react O2 in presence of H2 and catalyst to form H2O. Thus, the recombination catalyst is a catalyst which is capable of recombining any permeated hydrogen crossing over from the cathode of an electrolyzer PEM electrode assembly with oxygen in a controlled manner to form water, thereby reducing the amount of hydrogen entering the oxygen stream. Furthermore, the recombination catalyst is a catalyst which is capable of recombining any permeating oxygen crossing over from the anode of an electrolyzer PEM electrode assembly with hydrogen in a controlled manner to form water, thereby reducing the amount of oxygen entering the hydrogen stream. This may improve the purity of the hydrogen stream, removing or reducing the need for additional hydrogen processing steps. The recombination catalyst layers therefore reduce the amount of hydrogen crossing over into the oxygen stream and oxygen crossing over into the hydrogen stream.

In another embodiment, the recombination catalyst is a catalyst which is capable of recombining any permeated oxygen (O2), crossing over from the anode of an electrolyzer membrane assembly, with hydrogen in a controlled manner to form water, thereby reducing the amount of oxygen entering the hydrogen stream to enable higher purity H₂ product gas stream. A higher purity H₂ product gas stream may reduce additional processing steps downstream.

The recombination catalyst layers therefore reduce the amount of hydrogen crossing over into the oxygen stream. In other embodiments the recombination catalyst layers may reduce the amount of hydrogen crossing over into the oxygen stream and reduce the amount of oxygen crossing over into the hydrogen stream.

The composition of the at least two recombination catalyst layers may be the same or may be different. The at least two recombination catalyst layers may comprise one or more species of recombination catalysts. Each recombination catalyst layer may comprise a different recombination catalyst, or may each comprise the same recombination catalyst.

The recombination catalyst may comprise a single recombination catalyst species or a mixture of recombination catalyst species. The recombination catalyst is not particularly limited, and any known in the art may be used. The recombination catalyst may comprise one or more catalytic species selected from platinum (Pt), palladium (Pd), iridium (Ir), rhodium (Rh), ruthenium (Ru), osmium (Os), nickel (Ni), cobalt (Co), titanium (Ti), tin (Sn), tantalum (Ta), niobium (Nb), antimony (Sb), lead (Pb), manganese (Mn), an oxide thereof, and mixtures thereof. The recombination catalyst may comprise: at least one platinum group metal selected from platinum, palladium, iridium, rhodium, ruthenium and osmium; an alloy of the platinum group metal; a mixed oxide of the platinum group metal with other metals such as cerium and titanium; and mixtures thereof. The recombination catalyst preferably comprises platinum or palladium.

The recombination catalyst may comprise a catalyst particle size from about 0.1 nm to about 20 nm, or about 0.1 nm to about 15.0 nm, or about 1.0 nm to about 20.0 nm, or about 1.0 nm to about 10.0 nm, or about 2.0 nm to about 5.0 nm.

The recombination catalyst may be present on a support material. The support material is not particularly limited, and any known in the art may be used. The support material may comprise silica, zeolites, carbon, and oxides and carbides of Group IVB, VB, VIB, VIIB, and VIII transition metals, and combinations thereof. Carbon, such as particulate carbon or carbon black, is a preferable support material. Other forms of carbon, such as graphene and graphite, may also be used as the support material.

The support material preferably has a high surface area, and so should be small in mean particle size, for example, up to and including 150 nm, or up to and including about 75 nm, or up to and including about 50 nm, or up to and including about 25 nm, or up to and including about 5 nm. The mean particle size may be in the range of about 5 nm to about 150 nm, or in the range of about 10 nm to 75 nm, or about 10 nm to about 50 nm, or about 5 nm to about 25 nm, or any intermediate value or range of values. The use of a high surface area support material is particularly advantageous because it allows the recombination catalyst to be well dispersed, leading to higher catalytic activity per unit weight compared with an unsupported, lower surface area catalyst of the same composition.

The support material particles may be agglomerated together in groups of two, or three, or larger groupings of many particles. The agglomerated groupings may be separated into clusters of several particles.

In a preferred embodiment, the recombination catalyst may be platinum supported on a carbon particulate.

For a given recombination catalyst (with or without a support material) particle size, or an agglomerated particle size, the microporous polymer structure of the reinforcing layer can be selected to prevent the recombination catalyst particles or agglomerates from impregnating into the pores of the microporous polymer structure, for example by filtering. For example, the bubble point of the microporous polymer structure can be used to indicate characteristics of the microporous polymer structure which may effect this filtering process. For example, the recombination catalyst particle size or agglomerate particle size may be larger than the maximum or mean pore size of the microporous polymer structure of at least one of the at least two reinforcing layers. The region devoid of, or substantially devoid of recombination catalyst may be formed since the recombination catalyst (with or without the support material) may not impregnate into the pores of the microporous polymer structure. In one embodiment, the recombination catalyst agglomerated particle size may be between 1 μm to 20 μm, or between 0.5 μm to 5 μm, while the microporous polymer structure may have a bubble point of at least 100 kPa, for example, between about 100 kPa to about 3000 kPa, or between about 100 kPa to about 1000 kPa, or between about 100 kPa to about 800 kPa, or between about 100 kPa to about 700 kPa or between about 200 kPa to about 2000 kPa, or between about 200 kPa to about 1000 kPa, or between about 200 kPa to about 800 kPa, or between about 200 kPa to about 700 kPa, or between about 300 kPa to about 1000 kPa, or between about 300 kPa to about 800 kPa, or between about 300 kPa to about 700 kPa, or between about 400 kPa to about 800 kPa, or between about 400 kPa to about 700 kPa (wherein the bubble point of the microporous polymer structure is measured according to bubble point method as set out in the test methods section). The average pore size of the microporous polymer structure may be smaller than the recombination catalyst (with or without a support material) particle size, or an agglomerated particle size.

The recombination catalyst may be present in each of the at least two recombination catalyst layers at a loading that is effective for the particular requirements. The recombination catalyst may be present in each of the at least two recombination catalyst layers at a loading of up to about 0.10 mg/cm², or at a loading in the range of from about 0.001 mg/cm² to about 0.10 mg/cm²; or at a loading in the range of from 0.001 mg/cm² to about 0.09 mg/cm², or at a loading in the range of from about 0.005 mg/cm² to about 0.09 mg/cm², or at a loading in the range of from about 0.001 mg/cm² to about 0.08 mg/cm², or at a loading in the range of from about 0.0025 mg/cm² to about 0.08 mg/cm², or at a loading in the range of from about 0.005 mg/cm² to about 0.07 mg/cm², or at a loading in the range of from about 0.0075 mg/cm² to about 0.06 mg/cm², or at a loading in the range of from about 0.007 mg/cm² to about 0.05 mg/cm², or at a loading in the range of from about 0.008 mg/cm² to about 0.04 mg/cm², or at a loading in the range of from about 0.009 mg/cm² to about 0.03 mg/cm², or at a loading in the range of from about 0.0095 mg/cm² to about 0.02 mg/cm². The loading may be calculated based on the concentration of the recombination catalyst and the coating thickness of the recombination catalyst layer.

Water electrolyzers may experience an unfavourable side reaction between hydrogen and oxygen to form hydrogen peroxide (H₂O₂), which may decompose into peroxide radicals that can attack the PEM and electrolyzer components. To help mitigate this problem, at least one recombination catalyst layer, or any other layer in the PEM, may comprise one or more additives to decompose hydrogen peroxide and/or eliminate the peroxide radicals. The additive may be selected from a peroxide decomposition catalyst, a radical scavenger, a free radical decomposition catalyst, an antioxidant such as a self-regenerating antioxidant, a hydrogen donor primary antioxidant or a free radical scavenger secondary antioxidant, an oxygen absorbent, and the like.

The first ion exchange material is a material which is capable of cation exchange such as proton exchange. The first ion exchange material is not particularly limited, and any known in the art may be used. Mixtures of ion exchange materials may be used as the first ion exchange material. The first ion exchange material of each recombination catalyst layer may be the same or may be different. The term “first ion exchange material” is used to distinguish the ion exchange material of the recombination catalyst layers from the ion exchange material of the other layers of the PEM. In some examples, the ion exchange material in other layers may be the same as the first ion exchange material. In some examples, the first ion exchange material and the ion exchange material in other layers may be imbibed from the same imbibing dispersion.

The first ion exchange material may comprise at least one ionomer. The at least one ionomer may comprise a proton conducting polymer. The proton conducting polymer may be selected from a hydrocarbon ionomer, a perfluorinated ionomer and perfluorosulfonic acid ionomer. Suitable proton conducting polymers include perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl)imides, polyvinyl alcohol, polyethylene oxides, divinyl benzene, metal salts with or without a polymer, and mixtures thereof. The first ion exchange material preferably comprises a perfluorosulfonic acid (PFSA) polymer made by copolymerization of tetrafluoroethylene and perfluorosulfonyl vinyl ester with conversion into proton form. Examples of commercially available ion exchange materials include Nafion™ (E.I. DuPont de Nemours, Inc., Wilmington, Del., US), Flemion™ (Asahi Glass Co. Ltd., Tokyo, JP), Aciplex™ (Asahi Glass Co. Ltd., Tokyo, JP) and Aquivion™ (SolvaySolexis S.P.A, Italy), which are perfluorosulfonic acid copolymers.

The first ion exchange material may have a total equivalent weight (EW) from about 370 g/mol eq to about 2000 g/mol eq SO₃⁻. The ion exchange material may have a total equivalent weight (EW) from about 470 g/mol eq to about 1275 g/mol eq SO₃⁻. The ion exchange material may have a total equivalent weight (EW) from about 500 g/mol eq to about 1000 g/mol eq SO₃⁻. The ion exchange material may have a total equivalent weight (EW) from about 500 g/mol eq to about 900 g/mol eq SO₃⁻. The ion exchange material may have a total equivalent weight (EW) from about 650 g/mol eq to about 800 g/mol eq SO₃. The ion exchange material may have an equivalent weight of about 725 g/mol eq SO₃⁻. The ion exchange material may have an equivalent weight of about 800 g/mol eq SO₃⁻.

As used herein, the “equivalent weight” of an ionomer or ion exchange material refers to the weight of polymer (in molecular mass) in the ionomer per sulfonic acid group. Thus, a lower equivalent weight indicates a greater acid content. The equivalent weight (EW) of the ionomer refers to the EW if that ionomer were in its proton form at 0% RH with negligible impurities. The term “ion exchange capacity” refers to the inverse of equivalent weight (1/EW).

The total average equivalent volume of ion exchange material may be from about 240 cc/mol eq to about 1200 cc/mol eq. The average equivalent volume of the ion exchange material may be from about 240 cc/mole eq to about 720 cc/mole eq. The average equivalent volume of the ion exchange material may be from about 350 cc/mole eq to about 475 cc/mole eq. The total average equivalent volume of ion exchange material may comprise the total volume of ion exchange material distributed between all the ion exchange material layers of the composite membrane. The ion exchange material may have a density not lower than about 1.9 g/cc at 0% relative humidity.

As used herein, the “equivalent volume” of an ionomer or ion exchange material refers to the volume of the ionomer per sulfonic acid group. The equivalent volume (EV) of the ionomer refers to the EV if that ionomer were pure and in its proton form at 0% RH, with negligible impurities.

The first ion exchange material may comprise an additive to decompose hydrogen peroxide and/or eliminate peroxide radicals. Water electrolyzers may experience unwanted side reactions between hydrogen and oxygen to form hydrogen peroxide (H₂O₂), which may decompose into peroxide radicals that can attack the membrane and electrolyzer components. The additive may be a peroxide decomposition catalyst, a radical scavenger, a free radical decomposition catalyst, a self-regenerating antioxidant, a hydrogen donor primary antioxidant, a free radical scavenger secondary antioxidant, an oxygen absorbent, and the like. The additive may comprise Ce, Mn, or their oxides. For example, the additive may be a cerium oxide (ceria).

The recombination catalyst of each of the at least two recombination catalyst layers may be dispersed in the first ion exchange material. The recombination catalyst may be uniformly dispersed in the first ion exchange material.

Each of the at least two recombination catalyst layers may have a thickness at 50% relative humidity (RH) of at least about 1 μm, or from about 1 μm to about 35 μm, or from about 5 am to about 35 μm, or from about 2 μm to about 35 μm, or from about 1 μm to about 20 μm, or from about 2 μm to about 20 μm, or from about 2 μm to about 19 μm, or from about 2 μm to about 18 μm, or from about 2 μm to about 17 μm, or from about 2 μm to about 16 μm, or from about 2 μm to about 15 μm, or from about 2 μm to about 14 μm, or from about 2 μm to about 13 μm, or from about 2 μm to about 12 μm, or from about 2 μm to about 11 μm, or from about 2 μm to about 10 μm, or from about 3 μm to about 10 μm, or from about 3 μm to about 9 μm, or from about 3 μm to about 8 μm, or from about 3 μm to about 7 μm, or a thickness in the range of from about 4 μm to about 7 μm. The thickness of the recombination catalyst layers may be measured through a SEM (scanning electron microscope image) of the PEM.

The PEM may comprise a total of two recombination catalyst layers, or a total of three recombination catalyst layers, or a total of four recombination catalyst layers, or total of five recombination catalyst layers.

At least two recombination catalyst layers are separated by a region devoid of or substantially devoid of a recombination catalyst. In the context of the present disclosure, a region (or layer) being “substantially devoid” of a recombination catalyst (or any other stated material) may mean that the region is completely devoid of recombination catalyst, such that the region does not contain any detectable amount of recombination catalyst. It may also mean that the region is largely devoid of recombination catalyst, but may contain a small or trace amount of recombination catalyst, for instance at the region's interface with a recombination catalyst layer. The small or trace amount of recombination catalyst may be a result of the manufacturing process employed to make the PEM, or may be a result of a small or trace amount of recombination catalyst migrating from the recombination catalyst layer to the adjacent, separating region. Where the region is substantially devoid of recombination catalyst, it is not intended that the region contains the recombination catalyst, but may be the practical reality of carrying out the manufacturing process for making the PEM. For example, when preparing a PEM comprising a recombination catalyst layer and a reinforcing layer, in this order, it may be the case that a small or trace amount of recombination catalyst from the recombination catalyst layer enters or seeps into the microporous polymer structure of the reinforcing layer at the interface of the recombination catalyst layer and the reinforcing layer. However, the reinforcing layer is still substantially devoid of recombination catalyst.

The region separating at least two recombination catalyst layers which is devoid of or substantially devoid of a recombination catalyst may have a thickness, d, at 50% RH of at least about 1 μm, or at least about 2 μm, or at least about 3 μm, or at least about 4 μm, or at least about 5 μm, or at least 10 μm, or at least 20 μm, or at least 30 μm, or at least 40 μm, or at least 50 μm, or at least 60 μm, or at least 70 μm, or at least 80 μm.

The at least two recombination catalyst layers may be separated by a region having a thickness d, wherein the thickness d is from about 1 μm to about 80 μm at 50% RH. The region may have a thickness, d from about 1 μm to about 70 μm, or from about 1 μm to about 60 μm, or from about 1 μm to about 50 μm, or from about 1 μm to about 40 μm, or from about 1 μm to about 30 μm, or from about 1 μm to about 20 μm, or from about 1 μm to about 12 μm, at 50% RH. The region may have a thickness, d from about 2 μm to about 80 μm, or from about 2 μm to about 60 μm, or from about 2 μm to about 50 μm, or from about 2 μm to about 40 μm, or from about 2 μm to about 30 μm, or from about 2 μm to about 20 μm, or from about 2 μm to about 12 μm, at 50% RH. The region may have a thickness, d from about 5 μm to about 80 μm, or from about 5 μm to about 60 μm, or from about 5 μm to about 50 μm, or from about 5 μm to about 40 μm, or from about 5 μm to about 30 μm, or from about 5 μm to about 20 μm, or from about 5 μm to about 12 μm, at 50% RH. The region may have a thickness, d from about 10 μm to about 80 μm, or from about 10 μm to about 60 μm, or from about 10 μm to about 50 μm, or from about 10 μm to about 40 μm, or from about 10 μm to about 30 μm, or from about 10 μm to about 20 μm, at 50% RH.

The region separating at least two recombination catalyst layers may contain at least one layer devoid of or substantially devoid of a recombination catalyst. The region may contain more than one layer, such as two, three layers, four layers, five layers or more than five layers.

The region or at least one layer devoid of or substantially devoid of a recombination catalyst separating the at least two recombination catalyst layers is not particularly limited, and may be a reinforcing region or layer, or an ion exchange material region or layer or combinations of both. The reinforcing layer and ion exchange material layer are described below. The at least one layer separating at least two recombination catalyst layers may comprise one layer, or two layers, or three layers, or four layers or five layer or more than five layers. Having a region or layer devoid of or substantially devoid of recombination catalyst separating at least two recombination catalyst layers (e.g. the region or layer devoid of or substantially devoid of recombination catalyst is sandwiched between two recombination catalyst layers) ensures that not all the recombination catalyst is in one layer and therefore helps to limit the unfavourable reactions occurring near the anode side of the PEM.

### [Reinforcing Layer]

The PEM comprises at least two reinforcing layers, each of the at least two reinforcing layers comprising a microporous polymer structure and a second ion exchange material which is at least partially imbibed within the microporous polymer structure. The reinforcing layers provide mechanical support for the PEM and are conductive to cations because the layers contain an ion exchange material. A suitable microporous polymer structure depends largely on the application in which the PEM is used. The microporous polymer structure may be chemically and thermally stable in the environment in which the PEM is used and is tolerant to any additive used in the PEM.

The PEM may comprise two reinforcing layers, or three reinforcing layers, or four reinforcing layers, or five reinforcing layers. In some embodiments, if two or more reinforcing layers are present, the reinforcing layers may be in direct contact with each other, i.e. adjacent layers. Alternatively, the reinforcing layers may not be in direct contact with each other, i.e. non-adjacent layers separated by a layer which is not a reinforcing layer.

As used herein, the term “reinforcing layer comprising a microporous polymer structure” is intended to refer to a layer using a microporous polymer structure having an initial thickness before coating of at least about 3 μm, optionally from about 4 μm to about 230 μm, or from about 5 μm to about 80 μm, or from about 5 μm to about 50 μm, or from about 5 μm to about 35 μm. The microporous polymer structure may have an initial average micropore size before coating from about 0.01 μm to about 5 μm, e.g., from 0.01 μm to 1 μm, or from 0.05 μm to 0.5 μm. According to various optional embodiments, the pores of the microporous polymer structure may have an average pore size from 0.01 μm to 5.0 μm, e.g., from 0.01 to 1 μm or from 0.05 to 0.5 μm.

Each of the reinforcing layers may have a thickness at 50% RH (relative humidity) of at least about 1 μm, or from about 1 μm to about 20 μm, or from about 2 μm to about 15 μm, or from about 3 μm to about 15 μm, or from about 3 μm to about 13 μm, or from about 3 μm to about 12 μm, or from about 3 μm to about 11 μm, or from about 3 μm to about 10 μm, or from about 3 μm to about 9 μm, or from about 4 μm to about 9 μm, or from about 4 μm to about 8 μm. The thickness of the reinforcing layers may be measured through a SEM (scanning electron microscope image) of the PEM.

Each of the at least two reinforcing layers comprise a microporous polymer structure. The microporous polymer structure provides support for the PEM.

As used herein, the term “microporous polymer structure” refers to a polymeric matrix that supports the ion exchange material, adding structural integrity and durability to the resulting composite membrane. In some exemplary embodiments, the microporous polymer structure may comprise expanded polytetrafluoroethylene (ePTFE). The ePTFE may in some examples, have a node and fibril structure. In other exemplary embodiments, the microporous polymer structure may comprise track etched polycarbonate membranes having smooth flat surfaces, high apparent density, and well defined pore sizes.

The composition of the at least two reinforcing layers may be the same or may be different. The PEM may comprise one or more microporous polymer structures. Each reinforcing layer may comprise a different microporous polymer structure or may each comprise the same microporous polymer structure.

The microporous polymer structure may comprise at least one fluorinated polymer. In one embodiment, the fluorinated polymer may be selected from polytetrafluoroethylene (PTFE), poly(ethylene-co-tetrafluoroethylene) (EPTFE), expanded polytetrafluoroethylene (ePTFE), polyvinylidene fluoride (PVDF), expanded polyvinylidene fluoride (ePVDF), expanded poly(ethylene-co-tetrafluoroethylene) (eEPTFE) and mixtures thereof. Preferably, the fluorinated polymer may be expanded polytetrafluoroethylene (ePTFE).

In another embodiment, the microporous polymer structure may comprise a hydrocarbon polymer. The hydrocarbon polymer may be selected from polyethylene, polypropylene, polycarbonate, polystyrene, polysulfone, polyethersulfone, polyethylene naphthalate and mixtures thereof.

The microporous polymer structure may have a bubble point of at least 100 kPa. The microporous polymer structure may have a bubble point of between about 100 kPa to about 3000 kPa, or between about 100 kPa to about 1000 kPa, or between about 100 kPa to about 800 kPa, or between about 100 kPa to about 700 kPa or between about 200 kPa to about 2000 kPa, or between about 200 kPa to about 1000 kPa, or between about 200 kPa to about 800 kPa, or between about 200 kPa to about 700 kPa or between about 300 kPa to about 1000 kPa, or between about 300 kPa to about 800 kPa, or between about 300 kPa to about 700 kPa, or between about 400 kPa to about 800 kPa, or between about 400 kPa to about 700 kPa (wherein the bubble point of the microporous polymer structure is measured according to bubble point method as set out in the test methods section).

Within the context of the present disclosure, the total content of the microporous polymer structure within the PEM may be presented in terms of the total volume of the microporous polymer structure in the PEM per the total volume of the PEM. This unit (cc/m²) can also be thought of as equivalent thickness of reinforcement polymer structure if the layer was not microporous (μm). Then the volume fraction of microporous polymer structure in the PEM per the total volume of the PEM can be estimated simply by dividing this equivalent thickness of reinforcement polymer structure by the total thickness of the PEM.

The total mass of the microporous polymer structure in the PEM is considered to be the sum of the mass of the microporous polymer structure in each of the reinforcing layers. The total mass per area of the microporous polymer structure in the PEM may be at least about 2 g/m², or at least about 3 g/m², or at least about 4 g/m², or at least about 5 g/m², or from about 2 g/m² to about 50 g/m², or from about 3 g/m² to about 40 g/m², or from about 4 g/m² to about 30 g/m², based upon the total area of the PEM.

In embodiments in which the microporous polymer structure comprises ePTFE, the total mass (in mass per area) of the microporous polymer structure within the PEM may be from about 8 g/m² to about 80 g/m², or from about 8 g/m² to about 70 g/m², or from about 8 g/m² to about 60 g/m², or from about 8 g/m² to about 60 g/m², or from about 8 g/m² to about 50 g/m², or from about or from about 8 g/m² to about 40 g/m², or from about 8 g/m² to about 35 g/m², or from about 8 g/m² to about 30 g/m², or from about 8 g/m² to about 20 g/m², or from about 8 g/m² to about 15 g/m² based on the total area of the composite membrane. The total mass per area of the microporous polymer structure may be from about 8 g/m² to about 30 g/m² based on the total area of the composite membrane. The total mass per area of the microporous polymer structure may be from about 10 g/m² to about 15 g/m² based on the total area of the composite membrane. The total content (in mass per area) of the microporous polymer structure within the PEM may be from about 20 g/m² to about 80 g/m², or from about 30 g/m² to about 70 g/m², or from about 20 g/m² to about 50 g/m², or from about 30 g/m² to about 60 g/m², based on the total area of the composite membrane.

The total volume fraction of the microporous polymer structure in the PEM may be less than 50%. The total volume fraction of the microporous polymer structure in the PEM may be between about 0.4% to about 50%, or between about 0.4% to about 40%, or between about 0.4% to about 30%. The total volume fraction of the microporous polymer structure in the PEM may be between about 1% to about 50%, or between about 1% to about 40%, or between about 1% to about 30%. The total volume fraction of the microporous polymer structure in the PEM may be between about 5% to about 50%, or between about 5% to about 40%, or between about 5% to about 30%.

Each of the at least two reinforcing layers may have a microporous polymer structure mass per area of at least about 1 g/m², or at least about 1.5 g/m², or at least about 2 g/m², or from about 1 g/m² to about 25 g/m², or from about 1.5 g/m² to about 20 g/m², or from about 2 g/m² to about 15 g/m², or from about 2.5 g/m² to about 10 g/m², based upon the total area of the PEM. The second ion exchange material is a material which is capable of cation exchange such as proton exchange. The second ion exchange material is not particularly limited, and any known in the art may be used. Mixtures of ion exchange materials may be used as the second ion exchange material. The second ion exchange material may be the same as the first ion exchange material or may be different to the first ion exchange material. In one embodiment the first ion exchange material and second ion exchange material are the same. The second ion exchange material of each reinforcing layer may be the same or may be different. The term “second ion exchange material” is used to distinguish the ion exchange material of the reinforcing layers from the ion exchange material of the other layers of the PEM. The first and second ion exchange materials may be imbibed from the same imbibing dispersion.

The second ion exchange material may comprise at least one ionomer. The at least one ionomer may comprise a proton conducting polymer. The proton conducting polymer may be selected from a hydrocarbon ionomer, a perfluorinated ionomer and perfluorosulfonic acid ionomer. Suitable proton conducting polymers include perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl)imides, polyvinyl alcohol, polyethylene oxides, divinyl benzene, metal salts with or without a polymer, and mixtures thereof. The second ion exchange material preferably comprises a perfluorosulfonic acid (PFSA) polymer made by copolymerization of tetrafluoroethylene and perfluorosulfonyl vinyl ester with conversion into proton form. Examples of commercially available ion exchange materials include Nafion™ (E.I. DuPont de Nemours, Inc., Wilmington, Del., US), Flemion™ (Asahi Glass Co. Ltd., Tokyo, JP), Aciplex™ (Asahi Glass Co. Ltd., Tokyo, JP) and Aquivion™ (SolvaySolexis S.P.A, Italy), which are perfluorosulfonic acid copolymers.

The second ion exchange material may have a total equivalent weight (EW) from about 370 g/mol eq to about 2000 g/mol eq SO₃⁻. The ion exchange material may have a total equivalent weight (EW) from about 470 g/mol eq to about 1275 g/mol eq SO₃⁻. The ion exchange material may have a total equivalent weight (EW) from about 500 g/mol eq to about 1000 g/mol eq SO₃⁻. The ion exchange material may have a total equivalent weight (EW) from about 500 g/mol eq to about 900 g/mol eq SO₃⁻. The ion exchange material may have a total equivalent weight (EW) from about 650 g/mol eq to about 800 g/mol eq SO₃⁻. The ion exchange material may have an equivalent weight of about 725 g/mol eq SO₃⁻. The ion exchange material may have an equivalent weight of about 800 g/mol eq SO₃⁻.

As used herein, the “equivalent weight” of an ionomer or ion exchange material refers to the weight of polymer (in molecular mass) in the ionomer per sulfonic acid group. Thus, a lower equivalent weight indicates a greater acid content. The equivalent weight (EW) of the ionomer refers to the EW if that ionomer were in its proton form at 0% RH with negligible impurities. The term “ion exchange capacity” refers to the inverse of equivalent weight (1/EW).

The total average equivalent volume of ion exchange material may be from about 240 cc/mol eq to about 1200 cc/mol eq. The average equivalent volume of the ion exchange material may be from about 240 cc/mole eq to about 720 cc/mole eq. The average equivalent volume of the ion exchange material may be from about 350 cc/mole eq to about 475 cc/mole eq. The total average equivalent volume of ion exchange material may comprise the total volume of ion exchange material distributed between all the ion exchange material layers of the composite membrane. The ion exchange material may have a density not lower than about 1.9 g/cc at 0% relative humidity.

As used herein, the “equivalent volume” of an ionomer or ion exchange material refers to the volume of the ionomer per sulfonic acid group. The equivalent volume (EV) of the ionomer refers to the EV if that ionomer were pure and in its proton form at 0% RH, with negligible impurities.

The second ion exchange material may comprise an additive to decompose hydrogen peroxide and/or eliminate peroxide radicals. Water electrolyzers may experience unwanted side reactions between hydrogen and oxygen to form hydrogen peroxide (H₂O₂), which may decompose into peroxide radicals that can attack the membrane and electrolyzer components. The additive may be a peroxide decomposition catalyst, a radical scavenger, a free radical decomposition catalyst, a self-regenerating antioxidant, a hydrogen donor primary antioxidant, a free radical scavenger secondary antioxidant, an oxygen absorbent, and the like. The additive may comprise Ce, Mn, or their oxides. For example, the additive may be a cerium oxide (ceria).

The second ion exchange material is at least partially imbibed (or impregnated) within the microporous polymer structure. The second ion exchange material which is at least partially imbibed within the microporous polymer structure may render the microporous polymer structure occlusive (i.e. the microporous polymer structure is characterized by a low volume of voids or is substantially impermeable to gases). The microporous polymer structure may be fully imbibed with the second ion exchange material.

Each of the at least two reinforcing layers may be devoid of or substantially devoid of a recombination catalyst. The meaning of “substantially devoid” is analogous to the meaning described above with respect to the recombination catalyst separating region.

At least two recombination catalyst layers may be separated by at least one reinforcing layer, or at least two reinforcing layers, or at least three reinforcing layers.

### [Ion Exchange Membrane Layer]

The PEM may further comprise an ion exchange material layer comprising a third ion exchange material, wherein the ion exchange material layer is devoid of or substantially devoid of a microporous polymer structure and a recombination catalyst. The meaning of “substantially devoid” is analogous to the meaning described above with respect to the recombination catalyst separating region.

The PEM may comprise one ion exchange material layer, or two ion exchange material layers, or three ion exchange material layers, or four ion exchange material layers, or five ion exchange material layers. If two or more ion exchange material layers are present, the ion exchange material layers may be in direct contact with each other, i.e. adjacent layers. Alternatively, the ion exchange material layers may not be in direct contact with each other, i.e. non-adjacent layers separated by a layer which is not an ion exchange material layer.

The third ion exchange material is a material which is capable of cation exchange such as proton exchange. The third ion exchange material is not particularly limited, and any known in the art may be used. Mixtures of ion exchange materials may be used as the third ion exchange material. The third ion exchange material may be the same as the first ion exchange material and/or the second ion exchange material, or may be different to the first ion exchange material and/or the second ion exchange material. It is preferred that the first ion exchange material, second ion exchange material and third ion exchange material are the same. The third ion exchange material of each ion exchange material layer may be the same or may be different. The term “third ion exchange material” is used to distinguish the ion exchange material of the ion exchange material layers from the ion exchange material of the other layers of the PEM. The third ion exchange material may be the same as the first and/or second ion exchange material. In examples where the first, second and third ion exchange material are the same, the ion exchange material may be formed into the ion exchange layer from the same dispersion of ion exchange material used to form the recombination catalyst and reinforcing layers.

The third ion exchange material may comprise at least one ionomer. The at least one ionomer may comprise a proton conducting polymer. The proton conducting polymer may be selected from a hydrocarbon ionomer, a perfluorinated ionomer and perfluorosulfonic acid ionomer. Suitable proton conducting polymers include perfluorosulfonic acid polymers, perfluorocarboxylic acid polymers, perfluorophosphonic acid polymers, styrenic ion exchange polymers, fluorostyrenic ion exchange polymers, polyarylether ketone ion exchange polymers, polysulfone ion exchange polymers, bis(fluoroalkylsulfonyl)imides, (fluoroalkylsulfonyl)(fluorosulfonyl)imides, polyvinyl alcohol, polyethylene oxides, divinyl benzene, metal salts with or without a polymer, and mixtures thereof. The second ion exchange material preferably comprises a perfluorosulfonic acid (PFSA) polymer made by copolymerization of tetrafluoroethylene and perfluorosulfonyl vinyl ester with conversion into proton form. Examples of commercially available ion exchange materials include Nafion™ (E. I. DuPont de Nemours, Inc., Wilmington, Del., US), Flemion™ (Asahi Glass Co. Ltd., Tokyo, JP), Aciplex™ (Asahi Glass Co. Ltd., Tokyo, JP) and Aquivion™ (SolvaySolexis S.P.A, Italy), which are perfluorosulfonic acid copolymers.

Each of the ion exchange material layers may have a thickness at 50% RH (relative humidity) of from about 1 μm to about 20 μm, or from about 2 μm to about 15 μm, or from about 2 am to about 14 μm, or from about 2 μm to about 13 μm, or from about 2 μm to about 12 μm, or from about 3 μm to about 12 μm, or from about 3 μm to about 11 μm, or from about 3 μm to about 10 μm, or from about 3 μm to about 9 μm. The thickness of the ion exchange material layer may be measured through a SEM of the PEM.

The third ion exchange material may have a total equivalent weight (EW) from about 370 g/mol eq to about 2000 g/mol eq SO₃⁻. The third ion exchange material may have a total equivalent weight (EW) from about 470 g/mol eq to about 1275 g/mol eq SO₃⁻. The third ion exchange material may have a total equivalent weight (EW) from about 500 g/mol eq to about 1000 g/mol eq SO₃⁻. The third ion exchange material may have a total equivalent weight (EW) from about 500 g/mol eq to about 900 g/mol eq SO₃⁻. The third ion exchange material may have a total equivalent weight (EW) from about 650 g/mol eq to about 800 g/mol eq SO₃⁻. The third ion exchange material may have an equivalent weight of about 725 g/mol eq SO₃⁻. The third ion exchange material may have an equivalent weight of about 800 g/mol eq SO₃⁻.

As used herein, the “equivalent weight” of an ionomer or ion exchange material refers to the weight of polymer (in molecular mass) in the ionomer per sulfonic acid group. Thus, a lower equivalent weight indicates a greater acid content. The equivalent weight (EW) of the ionomer refers to the EW if that ionomer were in its proton form at 0% RH with negligible impurities. The term “ion exchange capacity” refers to the inverse of equivalent weight (1/EW).

The total average equivalent volume of ion exchange material may be from about 240 cc/mol eq to about 1200 cc/mol eq. The average equivalent volume of the ion exchange material may be from about 240 cc/mole eq to about 720 cc/mole eq. The average equivalent volume of the ion exchange material may be from about 350 cc/mole eq to about 475 cc/mole eq. The total average equivalent volume of ion exchange material may comprise the total volume of ion exchange material distributed between all the ion exchange material layers of the composite membrane. The ion exchange material may have a density not lower than about 1.9 g/cc at 0% relative humidity.

As used herein, the “equivalent volume” of an ionomer or ion exchange material refers to the volume of the ionomer per sulfonic acid group. The equivalent volume (EV) of the ionomer refers to the EV if that ionomer were pure and in its proton form at 0% RH, with negligible impurities.

The third ion exchange material may comprise an additive to decompose hydrogen peroxide and/or eliminate peroxide radicals. Water electrolyzers may experience unwanted side reactions between hydrogen and oxygen to form hydrogen peroxide (H₂O₂), which may decompose into peroxide radicals that can attack the membrane and electrolyzer components. The additive may be a peroxide decomposition catalyst, a radical scavenger, a free radical decomposition catalyst, a self-regenerating antioxidant, a hydrogen donor primary antioxidant, a free radical scavenger secondary antioxidant, an oxygen absorbent, and the like. The additive may comprise Ce, Mn, or their oxides. For example, the additive may be a cerium oxide (ceria).

### [the Multi-Layered Proton Exchange Membrane]

The PEM may have a total thickness at 50% RH (relative humidity) of from about 20 μm to about 250 μm, or from about 20 μm to about 200 μm, or from about 20 μm to about 150 μm, or from about 20 μm to about 120 μm, or from about 20 μm to about 100 μm, or from about 20 μm to about 90 μm, or from about 20 μm to about 80 μm, or from about 20 μm to about 70 μm, or from about 20 μm to about 60 μm, or from about 20 μm to 50 μm, or from about 20 μm to 45 μm.

The thickness of the PEM is measured using a thickness gauge (obtained from Heidenhain Corporation, USA) as described below. The thickness of the individual layers in the PEM are measured through a SEM of the PEM. Generally, the thinner the membrane, the better the efficiency of water electrolysis. However, since hydrogen crossover is exacerbated by the use of a thin membrane, it is typical to use a membrane with a thickness of over 100 μm, sometimes over 200 μm, which adversely affects efficiency of water electrolysis. The PEM of the present disclosure allows for thicknesses of less than 100 μm to be used safely, and therefore allows for increased efficiency.

In the context of the present disclosure, a membrane or layer thickness of “x μm” refers to the usual meaning of membrane (or layer) thickness in the art, that is, a thickness direction of the membrane (or layer) having a length x μm. For the avoidance of doubt, each membrane (or layer) has a first direction and a second direction, the second direction being orthogonal to the first direction, and the first and second directions are each orthogonal to the thickness direction. The lengths of first direction and second direction are larger than the thickness direction length. The membrane (or layer) has two opposing main surfaces, and the first direction and second direction are in the same plane as a main surface, and the thickness direction is perpendicular to the plane of a main surface.

The at least two recombination catalyst layers are separated by a region devoid of or substantially devoid of a recombination catalyst. The region separating at least two recombination catalyst layers may contain at least one layer devoid of or substantially devoid of a recombination catalyst. The region may contain more than one layer, such as two layers, three layers, four layers, or five layers. The at least two recombination catalyst layers may be separated by a region with a thickness d, wherein the thickness, d, is from about 1 μm to about 20 μm at 50% relative humidity, or from about 2 μm to about 15 μm, or from about 2 am to about 12 μm, or from about 3 μm to about 11 μm, or from about 3 μm to about 10 μm, or from about 3 μm to about 9 μm, or from about 3 μm to about 8 μm. The region may have a thickness, d from about 1 μm to about 70 μm, or from about 1 μm to about 60 μm, or from about 1 μm to about 50 μm, or from about 1 μm to about 40 μm, or from about 1 μm to about 30 μm, or from about 1 μm to about 20 μm, or from about 1 μm to about 12 μm, at 50% RH. The region may have a thickness, d from about 2 μm to about 80 μm, or from about 2 μm to about 60 μm, or from about 2 μm to about 50 μm, or from about 2 μm to about 40 μm, or from about 2 μm to about 30 μm, or from about 2 μm to about 20 μm, or from about 2 μm to about 12 μm, at 50% RH. The region may have a thickness, d from about 5 μm to about 80 μm, or from about 5 μm to about 60 μm, or from about 5 μm to about 50 μm, or from about 5 μm to about 40 μm, or from about 5 μm to about 30 μm, or from about 5 μm to about 20 μm, or from about 5 μm to about 12 μm, at 50% RH. The region may have a thickness, d from about 10 μm to about 80 μm, or from about 10 μm to about 60 μm, or from about 10 μm to about 50 μm, or from about 10 μm to about 40 μm, or from about 10 μm to about 30 μm, or from about 10 μm to about 20 μm, at 50% RH. The thickness may be measured through a SEM.

When used in an electrolyzer, the PEM may have one main surface in contact with the anode. One recombination catalyst layer may form one main surface of the PEM which is in contact (or configured to be in contact) with the anode, and another recombination catalyst layer may be present at a distance from the anode recombination catalyst layer of at least about 5 μm, or at least about 6 μm, or at least about 7 μm, or at least about 8 μm, or at least about 9 μm, or at least about 10 μm, or at least about 20 μm, or at least about 30 μm, or at least about 40 μm, or at least about 50 μm, or at least about 60 μm, or at least about 70 μm, or at least about 80 μm or from about 1 μm to about 80 μm, or 2 μm to about 80 μm, 5 μm to about 80 μm, or 5 μm to about 25 μm, or from about 6 μm to about 20 μm, or from about 7 μm to about 15 μm, or from about 8 μm to about 14 μm. The distance corresponds to the thickness of the region separating the at least two recombination catalyst layers.

A recombination catalyst layer may be configured to be in contact with an anode of a multi-layered proton exchange membrane electrode assembly in which it is used. That is, a recombination catalyst layer forms one main surface of the PEM. Generally, it is preferred in terms of preventing hydrogen crossover for the recombination catalyst layers to be configured to be closer to the anode than the cathode. In some examples, additional recombination catalyst layers may be configured to be located closer to the cathode in order to mitigate against oxygen crossover. The position of the recombination catalyst layer or layers can be selected depending on the system design and intended operating conditions, for example, locating the recombination catalyst in different positions in the PEM, instead of in a single position, there can be recombination catalyst located in a broader regime of the PEM thickness. This could enable higher recombination effectiveness at a broader set of stack designs and assembly techniques as well as at different operating pressures and temperatures. This may also allow the PEM to maintain effectiveness over time, for example, as the system degrades.

### In One Embodiment, the PEM May Comprise at Least the Following Layers in the Order:

(i) a recombination catalyst layer;
(ii) a reinforcing layer;
(iii) a recombination catalyst layer;
(iv) a reinforcing layer,
   wherein the reinforcing layers are devoid of or substantially devoid of a recombination catalyst, and the recombination catalyst layers are devoid of or substantially devoid of a microporous polymer structure. No further layers are present between any of the layers (i) to (iv). That is, layer (i) is in contact with layer (ii), layer (ii) is in contact with layer (iii), and layer (iii) is in contact with layer (iv). Alternatively, further layers such as an ion exchange material layer may be present between any of the layers (i) to (iv). The PEM may further comprise (v) an ion exchange material layer, in contact with the reinforcing layer (iv), wherein the ion exchange material layer is devoid of or substantially devoid of a microporous polymer structure and a recombination catalyst. The PEM may further comprise ion exchange material and/or reinforcing layers after layer (v). In one embodiment the recombination catalyst layer (i) is intended, in use, to be at or closest to the anode of an electrolyser PEM electrode assembly.

### In Another Embodiment, the PEM May Comprise of the Following Layers in Order:

(i) recombination catalyst layer;
(ii) reinforcing layer;
(iii) recombination catalyst layer;
(iv) reinforcing layer;
(v) ion exchange material layer;
(vi) reinforcing layer;
(vii) ion exchange material layer;
(viii) reinforcing layer; and
(ix) ion exchange material layer.

### In Another Embodiment, the PEM May Comprise of the Following Layers in Order:

(i) recombination catalyst layer;
(ii) reinforcing layer;
(iii) recombination catalyst layer;
(iv) reinforcing layer;
(v) ion exchange material layer;
(vi) reinforcing layer;
(vii) ion exchange material layer.

### In Another Embodiment, the PEM May Comprise at Least the Following Layers in the Order:

(i) a reinforcing layer
(ii) a recombination catalyst layer;
(iii) anion exchange material layer;
(iv) a recombination catalyst layer;
(v) a reinforcing layer,
   wherein the reinforcing layers are devoid of or substantially devoid of a recombination catalyst, the recombination catalyst layers are devoid of or substantially devoid of a microporous polymer structure, and the ion exchange material layer is devoid of or substantially devoid of a microporous polymer structure and a recombination catalyst. No further layers are present between any of the layers (i) to (v). That is, layer (i) is in contact with layer (ii), layer (ii) is in contact with layer (iii), layer (iii) is in contact with layer (iv), and layer (iv) is in contact with layer (v). Alternatively, further layers such as an ion exchange material layer may be present between any of the layers (i) to (v). Alternatively, ion exchange material layers may be present on the outer surfaces of the reinforcing layers (i) and (v). In one embodiment the recombination catalyst layer (ii) is intended to be closest to the anode of an electrolyser PEM electrode assembly.

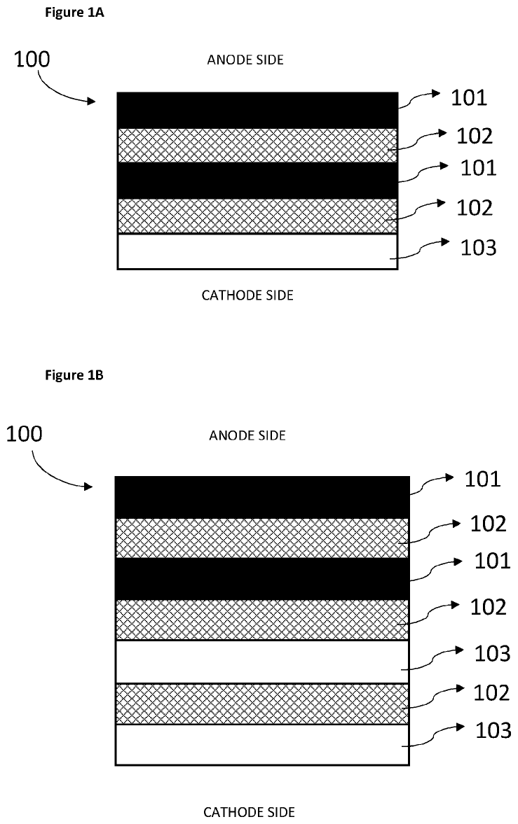

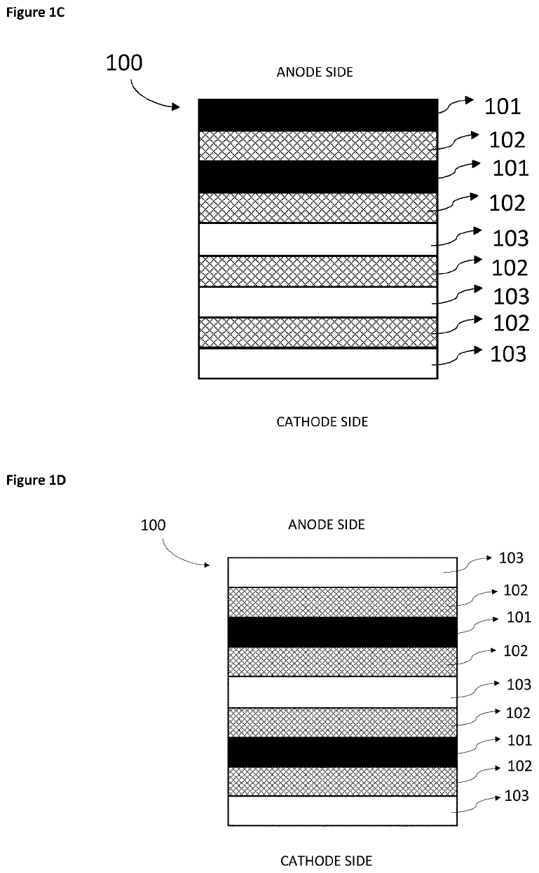

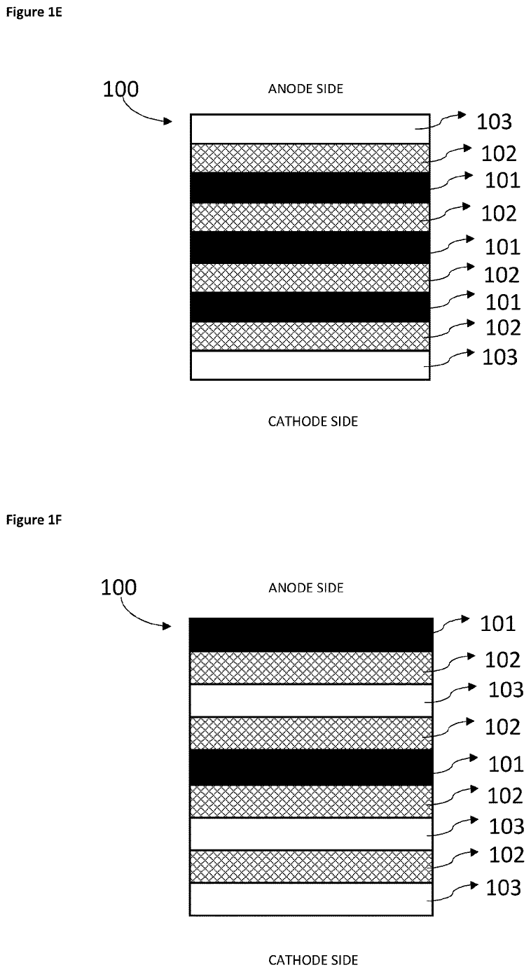

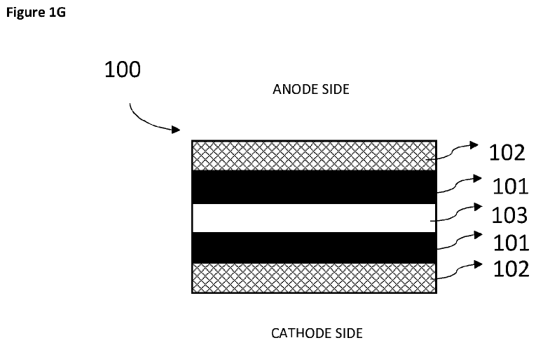

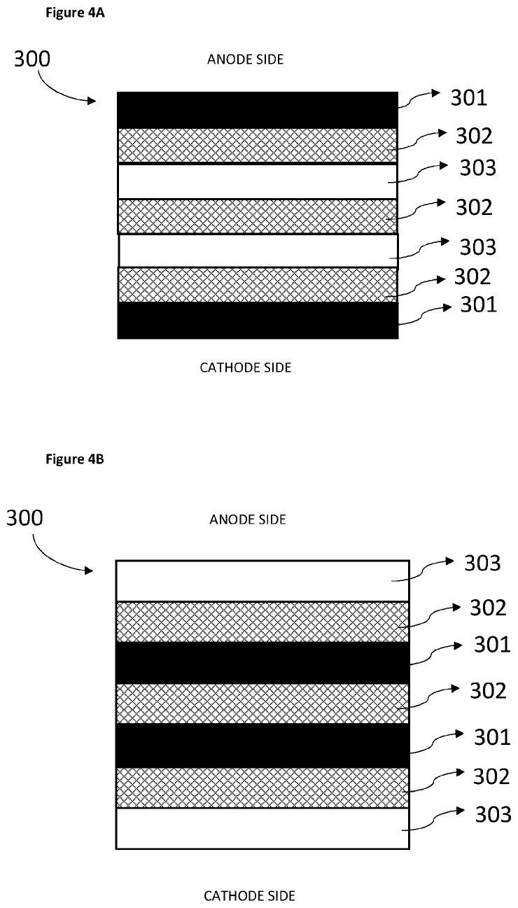

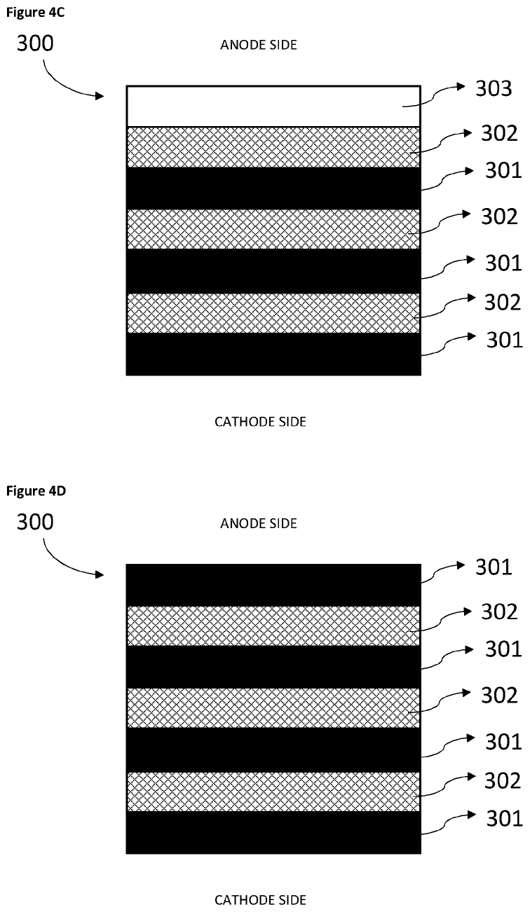

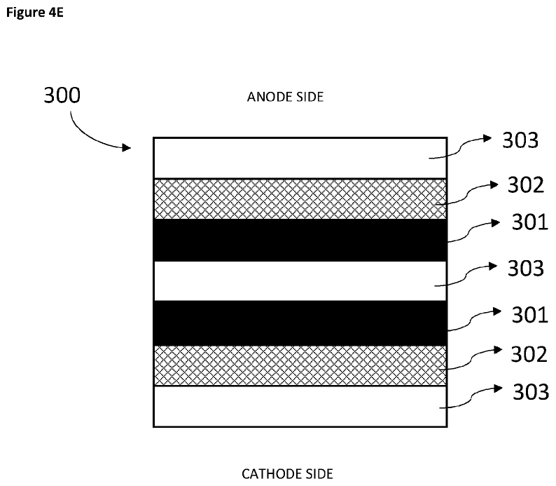

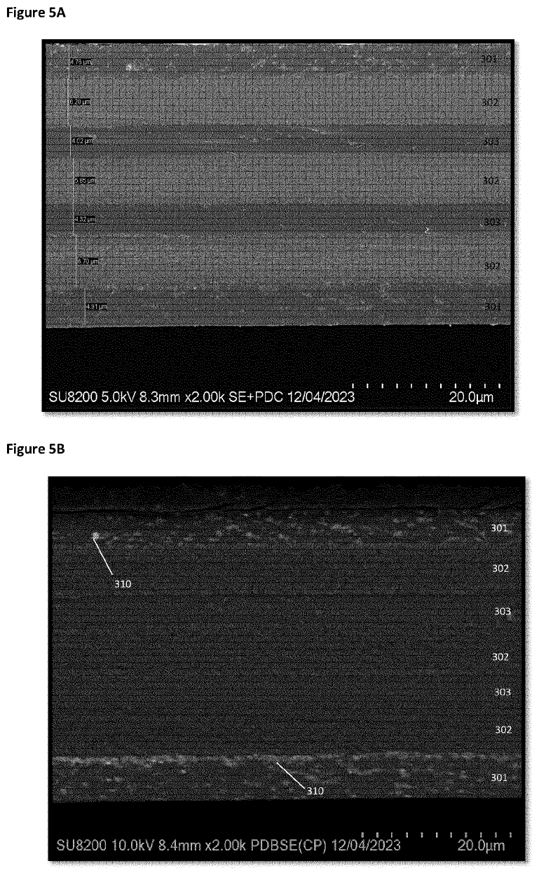

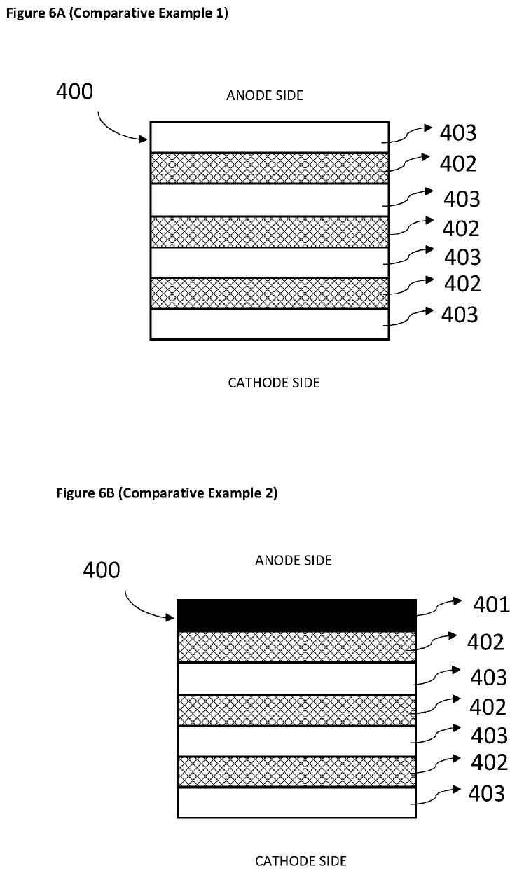

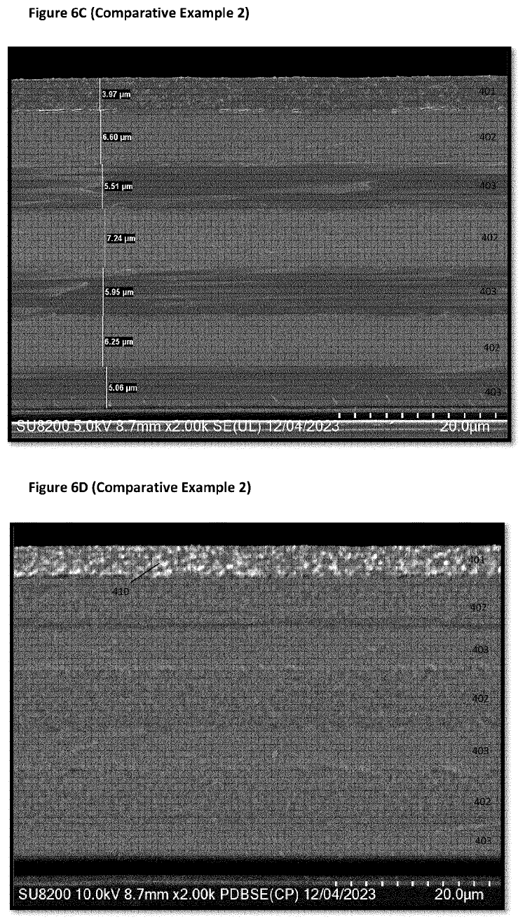

FIGS. 1A to 1G and FIGS. 4A to 4E show various PEMs according to the present disclosure. Reference numeral 101 refers to a recombination catalyst layer. Reference numeral 102 refers to a reinforcing layer. Reference numeral 103 refers to an ion exchange material layer. The preferred orientation of the PEMs with respect to a cathode and an anode of an electrolyzer are also depicted in FIGS. 1A to 1G, and FIGS. 4A to 4E. The layer order of the PEMs depicted in FIGS. 1A and 1G, and FIGS. 4A to 4E are exemplary only, and do not limit the scope of the present disclosure. FIGS. 6A and 6B show PEMs according to the comparative examples 1 and 2, respectively.

FIG. 1A shows a PEM 100 comprising the following layers starting from a bottom layer (i) of the PEM 100, wherein in use, a top layer (v) is intended to be at or closest to an anode side of an electrolyser PEM electrode assembly:
i) an ion exchange material layer 103;
(ii) a first reinforcing layer 102;
(iii) a first recombination catalyst layer 101;
(iv) a second reinforcing layer 102;
(v) a second recombination catalyst layer 101.

This example arrangement is advantageous because the positioning of the recombination catalyst layers (iii) and (v) maximises reduction in hydrogen crossover by allowing, particularly in thinner membranes, high recombination catalyst loading ability near to the crossover reaction front. This is particularly the case when compared to the provision of a recombination catalyst layer at a top surface of the PEM (i.e. at or immediately adjacent the anode) and where there will be limitations for increasing the recombination catalyst loading.

FIG. 1B shows a PEM 100 according to Example 2 comprising the following layers starting from a bottom layer (i) of the PEM 100, wherein in use, a top layer (vii) is intended to be at or closest to an anode side of an electrolyser PEM electrode assembly:
i) a first ion exchange material layer 103
(ii) a first reinforcing layer 102;
(iii) a second ion exchange material layer 103
(iv) a second reinforcing layer 102;
(v) a first recombination catalyst layer 101;
(vi) a third reinforcing layer 102;
(vii) a second recombination catalyst layer 101;
   This example arrangement provides the same advantages as that described above for FIG. 1A, and additionally the increased reinforcing layers provides for increased mechanical strength of the PEM and reduced crossover gas flux.

FIG. 1C shows a PEM 100 according to Example 1, comprising the following layers starting from a bottom layer (i) of the PEM 100, wherein in use, a top layer (ix) is intended to be at or closest to an anode side of an electrolyser PEM electrode assembly:
i) a first ion exchange material layer 103;
(ii) a first reinforcing layer 102;
(iii) a second ion exchange material layer 103; 101;
(iv) a second reinforcing layer 102;
(v) a third ion exchange material layer 103;
(vi) a third reinforcing layer 102;
(vii) first recombination catalyst layer 101;
(viii) a fourth reinforcing layer 102;
(ix) a second recombination catalyst layer.
   This example arrangement provides the same advantages as that described above for FIG. 1A, and additionally the increased reinforcing layers provides for increased mechanical strength of the PEM and reduced crossover gas flux.

FIG. 1D shows a PEM 100 comprising the following layers starting from a bottom (i) layer of the PEM 100, wherein in use, a top layer (ix) is intended to be at or closest to an anode side of an electrolyser PEM electrode assembly:
i) a first ion exchange material layer 103;
ii) a first reinforcing layer 102;
iii) a first recombination catalyst layer 101;
iv) a second reinforcing layer 102;
v) a second ion exchange material layer 103;
vi) a third reinforcing layer 102;
vii) a second recombination catalyst layer 101;
viii) a fourth reinforcing layer 102;
ix) a third ion exchange material layer 103.

This example arrangement provides the same advantages as that described above for FIG. 1D, and additionally, this arrangement allows for better optimized locations for the recombination catalyst layers to be most effective in reducing hydrogen crossover and oxygen crossover based on electrolysis operating pressure and conditions. Additionally, the arrangement may reduce degradation effects in the membrane by distancing the recombination catalyst layers from the electrode facing sides. FIG. 1E shows a PEM 100 comprising the following layers starting from a bottom layer (i) of the PEM 100, wherein in use, a top layer (ix) is intended to be at or closest to an anode side of an electrolyser PEM electrode assembly:
i) a first ion exchange material layer 103;
ii) a first reinforcing layer 102;
iii) a first recombination catalyst layer 101;
iv) a second reinforcing layer 102;
v) a second recombination catalyst layer 101;
vi) a third reinforcing layer 102;
vii) a third recombination catalyst layer 101;
viii) a fourth reinforcing layer 102;
ix) a second ion exchange material layer 103.
   This example arrangement provides the same advantages as that described above for FIG. 1D. and Additionally, this arrangement provides additional recombination catalyst loading capacity if needed based on electrolysis operating pressure and conditions by having three recombination catalyst layers and this can be beneficial for effective hydrogen and oxygen crossover reductions as well as easier processing by distributing the recombination catalyst concentrations needed over 3 layers. This arrangement may also reduce degradation effects in the membrane by distancing the recombination catalyst layers from the electrode facing sides. For example, when used in an electrolyzer and as the system degrades over time, the broader distribution of recombination catalyst through the PEM thickness could enable maintaining effective recombination over time as the system degrades, for instance if the degree of supersaturation changes.

FIG. 1F shows a PEM 100 comprising the following layers starting from a bottom layer (i) of the PEM 100, wherein in use, a top layer (ix) is intended to be at or closest to an anode side of an electrolyser PEM electrode assembly:
i) a first ion exchange material layer 103;
ii) a first reinforcing layer 102;
iii) a second ion exchange material layer 103;
iv) a second reinforcing layer 102;
v) a first recombination catalyst layer 101;
vi) a third reinforcing layer 102;
vii) a third ion exchange material layer 103.
viii) a fourth reinforcing layer 102;
ix) a second recombination catalyst layer 101.
   This example arrangement provides the same advantages as that described above for FIG. 1D, and additionally this arrangement allows for better optimized locations for the recombination catalyst layers to be most effective in reducing hydrogen crossover and oxygen crossover based on electrolysis operating pressure and conditions. For example, when used in an electrolyzer and as the system degrades over time, the broader distribution of recombination catalyst through the PEM thickness could enable maintaining effective recombination over time as the system degrades, for instance if the degree of supersaturation changes.

FIG. 1G shows a PEM 100 comprising the following layers starting from a bottom layer (i) of the PEM 100, wherein in use, a top layer (v( ) is intended to be at or closest to an anode side of an electrolyser PEM electrode assembly:
(i) a reinforcing layer 102;
(ii) a recombination catalyst layer 101;
(iii) an ion exchange material layer 103;
(iv) a recombination catalyst layer 101;
(v) a reinforcing layer 102.
   This example arrangement provides the same advantages as that described above for FIG. 1A, and additionally it may reduce degradation effects in the membrane by distancing the recombination catalyst layers from the electrode facing sides.

FIG. 4A shows a PEM 300 according to Example 3, comprising the following layers starting from a bottom layer (i) of the PEM 300, wherein in use, a top layer (vii) is intended to be at or closest to an anode side of an electrolyser PEM electrode assembly:
i) a first recombination catalyst layer 301;
ii) a first reinforcing layer 302;
iii) a first ion exchange material layer 303;
iv) a second reinforcing layer 302;
v) a second ion exchange material layer 303;
vi) a third reinforcing layer 302;
vii) a second recombination catalyst layer 301.

This example arrangement provides the same advantages as that described above for FIG. 1B, and additionally it can enable the reduction of oxygen crossover for improved hydrogen purity by placing a recombination catalyst layer near the cathode facing side.

FIG. 4B shows a PEM 300 comprising the following layers starting from a bottom layer (i) of the PEM 300, wherein in use, a top layer (vii) is intended to be at or closest to an anode side of an electrolyser PEM electrode assembly:
i) a first ion exchange material layer 303;
ii) a first reinforcing layer 302;
iii) a first recombination catalyst layer 301
iv) a second reinforcing layer 302;
v) a second recombination catalyst layer 301;
vi) a third reinforcing layer 302;
vii) a second ion exchange material layer 303.
   This example arrangement provides the same advantages as that described above for FIG. 4A, and additionally it may reduce degradation effects in the membrane by distancing the recombination catalyst layers from the electrode facing sides. For example, when used in an electrolyzer and as the system degrades over time, the broader distribution of recombination catalyst through the PEM thickness as shown in FIG. 4B could enable maintaining effective recombination over time as the system degrades, for instance if the degree of supersaturation changes.

FIG. 4C shows a PEM 300 comprising the following layers starting from a bottom layer (i) of the PEM 300, wherein in use, a top layer (vii) is intended to be at or closest to an anode side of an electrolyser PEM electrode assembly:
i) a first recombination catalyst layer 301;
ii) a first reinforcing layer 302;
iii) a second recombination catalyst layer 301
iv) a second reinforcing layer 302;
v) a third recombination catalyst layer 301;
vi) a third reinforcing layer 302;
vii) a first ion exchange material layer 303.

This example arrangement provides the same advantages as that described above for FIG. 4A, and additionally it provides additional recombination catalyst loading capacity if needed based on electrolysis operating pressure and conditions by having three recombination catalyst layers that can be beneficial for effective hydrogen and oxygen crossover reductions as well as easier processing by distributing the recombination catalyst concentrations needed over 3 layers. For example, when used in an electrolyzer and as the system degrades over time, the broader distribution of recombination catalyst through the PEM thickness as shown in FIG. 4C could enable maintaining effective recombination over time as the system degrades, for instance if the degree of supersaturation changes.

FIG. 4D shows a PEM 300 comprising the following layers starting from a bottom layer (i) of the PEM 300, wherein in use, a top layer (vii) is intended to be at or closest to an anode side of an electrolyser PEM electrode assembly:
i) a first recombination catalyst layer 301;
ii) a first reinforcing layer 302;
iii) a second recombination catalyst layer 301
iv) a second reinforcing layer 302;
v) a third recombination catalyst layer 301;
vi) a third reinforcing layer 302;
vii) a fourth recombination catalyst layer 301.
   This example arrangement provides the same advantages as that described above for FIG. 4A, and additionally it provides additional recombination catalyst loading capacity if needed based on electrolysis operating pressure and conditions by having four recombination catalyst layers that can be beneficial for effective hydrogen and oxygen crossover reductions as well as easier processing by distributing the recombination catalyst concentrations needed over 4 layers. For example, when used in an electrolyzer and as the system degrades over time, the broader distribution of recombination catalyst through the PEM thickness as shown in FIG. 4D could enable maintaining effective recombination over time as the system degrades, for instance if the degree of supersaturation changes.

FIG. 4E shows a PEM 300 comprising the following layers starting from a bottom layer (i) of the PEM 300, wherein in use, a top layer (vii) is intended to be at or closest to an anode side of an electrolyser PEM electrode assembly:
i) a first ion exchange material layer 303;
ii) a first reinforcing layer 302;
iii) a first recombination catalyst layer 301
iv) a second ion exchange material layer 303;
v) a second recombination catalyst layer 301;
vi) a second reinforcing layer 302;
vii) a third ion exchange material layer 303.
   This example arrangement provides the same advantages as that described above for FIG. 4A, and additionally it may reduce degradation effects in the membrane by distancing the recombination catalyst layers from the electrode facing sides

FIG. 6A (comparative example 1) shows a PEM 400 comprising the following layers starting from a bottom layer (i) of the PEM 400, wherein in use, a top layer (vii) is intended to be at or closest to an anode side of an electrolyser PEM electrode assembly:
i) a first ion exchange material layer 403;
(ii) a first reinforcing layer 402;
(iii) a second ion exchange material layer 403
(iv) a second reinforcing layer 402;
(v) a third ion exchange material layer 403;
(vi) a third reinforcing layer 402.
(vii) a fourth ion exchange material layer 403

FIG. 6B (comparative example 2) shows a PEM 400 comprising the following layers starting from a bottom layer (i) of the PEM 400, wherein in use, a top layer (vii) is intended to be at or closest to an anode side of an electrolyser PEM electrode assembly:
i) a first ion exchange material layer 403;
(ii) a first reinforcing layer 402;
(iii) a second ion exchange material layer 403
(iv) a second reinforcing layer 402;
(v) a third ion exchange material layer 403;
(vi) a third reinforcing layer 402;
(vii) a first recombination catalyst layer 401.

### [A Method of Manufacturing the Multi-Layered Proton Exchange Membrane]

A method of manufacturing the PEM may comprise the general steps of: forming at least two reinforcing layers, at least two recombination catalyst layers, and optionally one or more further layers, in any order, with the proviso that the resulting PEM comprises at least two recombination catalyst layers which are separated by a region devoid of or substantially devoid of a recombination catalyst.

The PEM may be prepared by a sequential coating process, where the composite structure is formed by depositing coatings on the surface of prior layers, wherein the prior layers may comprise a backer, a microporous polymer structure, or an intermediate composite layered structure. In one example, each layer of the PEM is sequentially coated onto a backer layer/each other in the desired order. The process typically starts with coating a layer (e.g. a recombination catalyst layer or an ion exchange material layer) onto a backer layer. In the case of an ion exchange material layer, a dispersion comprising the third ion exchange material is deposited onto the backer layer. In some examples, no backer is provided.

In the case of a recombination catalyst layer, a dispersion comprising the first ion exchange material and the recombination catalyst is deposited onto the backer layer. In the case of a reinforcing layer, in one embodiment a microporous polymer structure is deposited onto a layer comprising the second ion exchange material, and the microporous polymer structure is allowed to become at least partially imbibed with the ion exchange material. In another embodiment, a dispersion comprising an ion exchange material (first or second) and the recombination catalyst is deposited onto the backer layer and a microporous polymer structure is deposited onto the dispersion layer. The microporous polymer structure is allowed to become at least partially imbibed with part of the ion exchange material while the microporous polymer structure acts as a filter for the recombination catalyst, wherein the recombination catalyst remains in the dispersion which has not imbibed into the microporous polymer structure. Said coating step forms two PEM layers in one step: a recombination catalyst layer and a reinforcing layer. After each coating step, the multi-layered structure (or laminate) may be optionally dried. In particular after the coating steps processing recombination catalyst, a drying step can be included in order to hold the recombination catalyst within the respective recombination catalyst layer and prevent any movement of the recombination catalyst into other layers of the PEM if a microporous polymer structure is not being deposited on to the dispersion layer. This process is completed until the final membrane is formed. An ion exchange material layer and adjacent reinforcing layer may be similarly formed in one step, wherein the ion exchange material layer is formed by a layer of dispersion of ion exchange material which has not imbibed into the microporous polymer structure forming the reinforcing layer.

The skilled person would know how to vary the thickness of each layer, the concentrations of catalyst and additives, etc. in order to prepare a PEM according to the present disclosure.

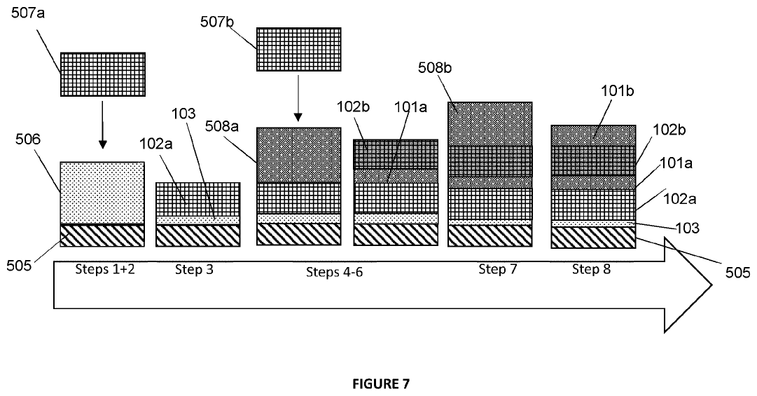

FIG. 7 shows a schematic of a process for the production of a PEM according to the present disclosure. For example, to produce the exemplary PEM according to FIG. 1A comprising of the following layers in order (starting from a bottom layer, wherein in use the bottom layer is intended to be positioned at or closest to the cathode): first ion exchange material layer (103), first reinforcing layer (102a), first recombination catalyst layer (101a), second reinforcing layer (102b), second recombination catalyst layer (101b), the following process may be employed.

In a first step, as shown schematically in FIG. 7, a first dispersion 506 comprising the second ion exchange material is deposited onto a backer layer 505 (not visible in FIG. 1A).

In a second step, a first microporous polymer structure 507a is deposited onto the second ion exchange material dispersion 506, and the first microporous polymer structure 507a is allowed to become at least partially imbibed with the second ion exchange material dispersion 506.

In an optional third step, the imbibed microporous polymer structure 507a and the second ion exchange material dispersion 506 is dried forming the first ion exchange material layer 103 and the first reinforcing layer 102a.

In a fourth step, a second dispersion 508a comprising the first ion exchange material and a recombination catalyst is deposited onto the first reinforcing layer 102a (or on top of the at least partially imbibed first microporous polymer structure 507a if this has not yet been dried to form reinforcing layer 102a) and in a fifth step, a second microporous polymer structure 507b is deposited onto the second dispersion 508a comprising the first ion exchange material and the recombination catalyst. The second microporous polymer structure 507b is allowed to become at least partially imbibed with part of the ion exchange material of the dispersion 508a to form the second reinforcing layer 102b. The recombination catalyst in the first dispersion 508a is unable to imbibe into the second microporous polymer structure 507b, and also the at least partially imbibed first microporous polymer structure 507a because the particle size of the catalyst or aggregates of the catalyst particles (or the catalyst and support material particles or aggregates) are larger than the pore size of the second microporous polymer structure 507b. Thus, the recombination catalyst is filtered out by the microporous polymer structure 507b and is retained in the portion of dispersion 508a which does not imbibe into the second microporous polymer structure 507b, and will form the first recombination catalyst layer 101a. In an optional sixth step, the intermediate composite of step five is then dried to form the second reinforcing layer 102b and first recombination catalyst layer 101a on top of the intermediate composite described in step three. The first recombination catalyst layer 101a is arranged between the first reinforcing layer 102a and the second reinforcing layer 102b.

In a seventh step, a third dispersion 508b comprising an ion exchange material and recombination catalyst is deposited onto the second reinforcing layer 102b (or on top of the at least partially imbibed second microporous polymer structure 507b if this has not yet been dried to form reinforcing layer 102b) and again, the recombination catalyst cannot imbibe into the second reinforcing layer 102b, and the second recombination catalyst layer 101b is formed on a surface of the second reinforcing layer 102b as show in FIG. 6. The third dispersion 508b comprising ion exchange material and recombination catalyst can be the same as the second dispersion 508a or different, for example, comprising a different ion exchange material and/or a different recombination catalyst, and/or a different concentration of recombination catalyst, and/or the same or different solvents or system of solvents, and/or the same or different concentrations of total solids to solvents.

In an eight step, the multi-layered structure is dried to form the PEM 100. The second recombination catalyst 101b forms an outer surface of the PEM 100.

During the manufacturing process, a small or trace amount of recombination catalyst may migrate or seep into the microporous polymer structure of the reinforcing layer. However, the amount is minimal and it is not intended. Therefore, the reinforcing layer comprising the microporous polymer structure is said to be substantially devoid of recombination catalyst layer, as explained above. To help prevent this migration of recombination catalyst, one optional technique is to dry each layer before applying the next layer so there is no liquid that can seep into the microporous polymer structure.

### [Multi-Layered Proton Exchange Membrane Electrode Assembly]

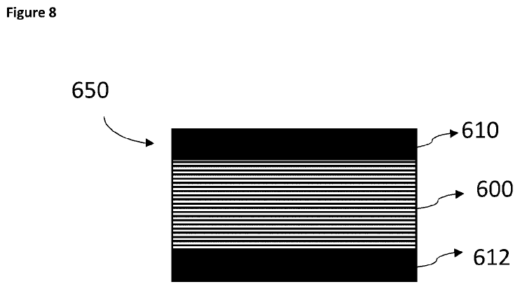

A PEM electrode assembly may comprise: at least one electrode; and the PEM of the present disclosure in contact with the at least one electrode. FIG. 8 shows a schematic of a PEM electrode assembly 650 comprising an anode 610, a cathode 612, and PEM assembly 600 according to the present disclosure positioned therebetween.

The PEM may be attached to or in contact with the at least one electrode. The electrode assembly may comprise a first electrode and a second electrode, wherein the first electrode is an anode and the second electrode is a cathode. The anode may be in contact with a recombination catalyst layer of the PEM. The cathode may be in contact with a recombination catalyst layer of the PEM. For instance, in the exemplary PEM according to FIG. 1A, consisting of the following layers in order (starting from a bottom layer, wherein in use the bottom layer is intended to be positioned at or closest to the cathode): first ion exchange material layer 103; first reinforcing layer 102; first recombination catalyst layer 101; second reinforcing layer 102; second recombination catalyst layer 101; the second recombination catalyst layer 101 may be in contact with the anode and the first ion exchange material layer 103 may be in contact with the cathode. For instance, in the exemplary PEM according to FIG. 4A, consisting of the following layers in order (starting from a bottom layer, wherein in use the bottom layer is intended to be positioned at or closest to the cathode): a first recombination catalyst layer 301, a first reinforcing layer 302, a first ion exchange material layer 303; a second reinforcing layer 302; a second ion exchange material layer 303; a third reinforcing layer 302, and a second recombination catalyst later 301; the second recombination catalyst layer 301 may be in contact with the anode and the first recombination catalyst layer 301 may be in contact with the cathode.

Any suitable anode and cathode materials known in the art may be used. The electrodes may be porous. Typical anode materials for PEM water electrolysis include iridium. Typical cathode materials for PEM water electrolysis include platinum.

The PEM electrode assembly may further comprise a fluid diffusion layer. The fluid diffusion layer may be any suitable fluid diffusion layer known in the art. For example, the fluid diffusion layer may be selected from a felt, a paper, a woven material, a carbon/carbon based diffusion layer, titanium porous sintered powder mesh, a stainless steel mesh and mixtures thereof.

Electrode assemblies may be prepared by depositing an anode on one surface of the PEM and depositing a cathode on the opposing surface of the PEM. The electrodes may be deposited by any suitable techniques known in the art. For example, solid electrode layers may be pressed against the PEM by any suitable techniques. Alternatively, liquid electrode inks may be applied to the PEM, and upon drying, the solvent of the electrode inks may dry to form a solid electrode layer. For the avoidance of doubt, the backer layer must be removed from the PEM before applying the electrode intended to be placed on that surface of the PEM.

### [Electrolyzer]

An electrolyzer comprising the PEM of the present disclosure or the PEM electrode assembly of the present disclosure is provided. An electrolyzer is an electrochemical device in which PEM water electrolysis may occur. The electrolyzer comprises at least a PEM, an anode and a cathode. The PEM electrode assembly 650 shown in FIG. 8 can be used in an electrolyzer.

### [Use of the Multi-Layered Proton Exchange Membrane in the Electrolysis of Water]

The PEM may be used in water electrolysis to produce hydrogen. Water electrolysis occurs in an electrolyzer comprising the PEM. During the electrolysis, the half reaction occurring at the anode is: 2H₂O→O₂+4H⁺+4 e⁻, and the half reaction occurring at the cathode is: 4H⁺+4 e⁻→2H₂. The H⁺ cations migrate from the anode to the cathode through the PEM to generate H₂ at the cathode.

### [Test Methods and Measurement Protocols]

The following test methods and measurement protocols apply to the above description and Examples.

Bubble Point: The Bubble Point was measured according to the procedures of ASTM F316-86. Isopropyl alcohol was used as the wetting fluid to fill the pores of the test specimen. The Bubble Point is the pressure of air required to create the first continuous stream of bubbles detectable by their rise through the layer of isopropyl alcohol covering the microporous polymer matrix. This measurement provides an estimation of pore characteristics including: maximum pore size, pore tortuosity, and surface energy.

Mass-per-area: each microporous polymer structure was strained sufficient to eliminate wrinkles, and then a 10 cm² piece was cut out using a die. The 10 cm² piece was weighed on a conventional laboratory scale. The mass-per-area (M/A) was then calculated as the ratio of the measured mass to the known area. This procedure was repeated two times and the average value of the M/A was calculated. Alternatively, a piece of known area can be cut out using a die, and the mass per area calculated as outlined above based on this known area.

Thickness of PEM: the PEMs were equilibrated in the room in which the thickness was measured for at least 1 hour prior to measurement. PEMs were left attached to the backer layers on which the PEMs were coated. For each sample, the PEM on its backer layer was placed on a smooth, flat, level marble slab. A thickness gauge (obtained from Heidenhain Corporation, USA) was brought into contact with the PEM and the height reading of the gauge was recorded in six different spots arranged in grid pattern on the membrane. Then, the sample was removed from the backer layer, the gauge was brought into contact with the backer layer, and the height reading was recorded again in the same six spots. The thickness of the PEM at a given relative humidity (RH) in the room was calculated as a difference between height readings of the gauge with and without the PEM being present. The local RH was measured using an RH probe (obtained from Fluke Corporation). The thickness at 0% RH was calculated using the following general formula:

$$PEM thickness at 0 \% RH == ( \frac{\begin{matrix}PEM membrane thickness at room RH - \\ \frac{M / {A}_{microporous polymer structure}}{{Density}_{microporous polymer structure}}\end{matrix}}{1 + \frac{{λ}_{room RH}}{{EW}_{ionomer \_ average}} * \frac{Molecular {weight}_{water}}{{Density}_{water}} * {Density}_{ionomer}} ) ** ( 1 + \frac{{λ}_{RH = 0 \%}}{{EW}_{{ionomer}_{average}}} * \frac{Molecular {weight}_{water}}{{Density}_{water}} * {Density}_{ionomer} ) + \frac{M / {A}_{microporous polymer structure}}{{Density}_{microporous polymer structure}} == [ micron ]$$

where the parameter λ corresponds to the water uptake of the ion exchange material in terms of moles of water per mole of acid group at a specified RH. For the PFSA ionomer of the examples (G701—IWI 100-700 from Asashi Glass Co., Japan), the values for λ at any RH in the range from 0 to 100% in gas phase were calculated according the following formula:

$$λ = 80.239 \times R {H}^{6} - 38.717 \times R {H}^{5} - 164.451 \times R {H}^{4} + 208.509 \times R {H}^{3} - 91.052 \times R {H}^{2} + 21. 740 \times R {H}^{1} + 0.084$$

Hydrogen and Oxygen Crossover Test: The hydrogen and oxygen crossover of the examples were determined by the following procedure: A catalyst Coated Membrane (CCM) with PEM from the examples was created by applying a cathode catalyst layer with 0.4 mg/cm² Platinum on Carbon support Product (50%/NE-F) supplied from N.E. CHEMCAT and an anode catalyst layer with 0.6 mg/cm² Iridium Oxide (Premion) supplied from Thermoscientific. The CCM was pre-conditioned at 80° C. in liquid De-ionized (DI) water for 24 hours prior to assembling in the test cell. A AvCarb MGL 280 supplied from AvCarb Material Solutions was used as a gas diffusion layer on the cathode side; Bekaert Ti felt (2GDL10-025) coated with Pt supplied from Bekeart was used as a porous transport layer on the anode side. A 25 cm² single cell was used for measurement. DI water was fed to anode side of cell. Cell and water temperatures were maintained at 80° C. during the measurement. The exhaust gas streams from anode and cathode were dried before being analyzed via a micro Gas Chromatography (GC) model Agilent 990 supplied from Teckso. Nitrogen (N2) and Helium (He) was used as the carrier gas for H₂ and O₂ concentration analysis respectively. The sampling frequency is 100 Hz and run time is 48 s. The N2 carrier gas injection temperature is set at 50 degrees Celsius, with injection time is 70 ms and backflush 7 seconds. For the He carrier gas, the injection time is 140 ms and everything else was the same as the N2 case. The H₂ concentration in O₂ is calculated as the ratio of H₂ concentration to O₂ concentration in the anode stream. The O₂ concentration level in H₂ was directly obtained from the cathode stream using the GC.

### EXAMPLES

The present disclosure will be described in more detail with reference to Examples. The present disclosure is not limited to the following Examples.

### Example 1 (FIG. 1C)

A PEM of the present disclosure was prepared in Example 1 as follows.

A first liquid dispersion was prepared to contain 11.2 wt % solids of a PFSA ionomer blend from Asahi Glass Co., Japan (G701=IW100-700 and G701NPC=IW101-700)) in a solvent blend of 35 wt % water and 65 wt % ethanol. The PFSA ionomer IW101-700 contains a cerium additive. The two ionomers were blended to achieve a Ce wt % of 0.0335% in dispersion. A second liquid dispersion was prepared to contain 11.2 wt % solids of PFSA ionomer from Asahi Glass Co., Japan (G701=IW100-700) in a solvent blend of 35 wt % water and 65 wt % ethanol. A mixture was formed from this second liquid dispersion containing platinum (Pt) supported on carbon from N. E. Chemcat Corporation (SA50BK) in a concentration of 0.164 wt % Pt total in the mixture.

A PET backer layer was coated with the first liquid dispersion in a wet thickness of approximately 150 μm, then a layer of ePTFE with a mass per area of approximately 4 g/m² (used as the microporous polymer structure) was placed on top of the first liquid dispersion and allowed to imbibe. The composite was then dried first at a temperature of approximately 105° C. for about 2.5 mins and then at a temperature of approximately 150° C. for about 2.5 mins forming a first ion exchange material layer and a first reinforcing layer. This intermediate composite was then coated with the same first liquid dispersion at a wet thickness of approximately 150 μm, then a second layer of the same ePTFE with a mass per area of approximately 4 g/m² (used as the microporous polymer structure) was placed on top of the first liquid dispersion and allowed to imbibe. The composite was then dried first at a temperature of approximately 105° C. for about 2.5 mins and then at a temperature of approximately 150° C. for about 2.5 mins forming a second ion exchange material layer and a second reinforcing layer. This composite was then coated with the same first liquid dispersion at a wet thickness of approximately 150 μm, then a third layer of the same ePTFE with a mass per area of approximately 4 g/m² (used as the microporous polymer structure) was placed on top of the dispersion and allowed to imbibe. The composite was then dried first at a temperature of approximately 105° C. for about 2.5 mins and then at a temperature of approximately 150° C. for about 2.5 mins forming a third ion exchange material layer and a third reinforcing layer.

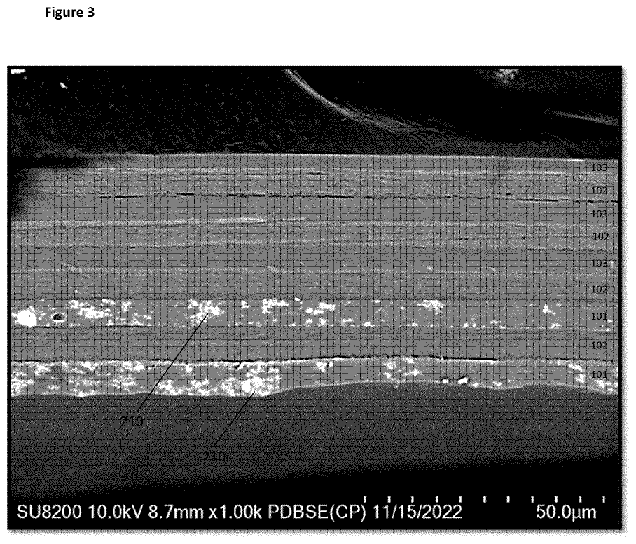

This composite was then coated with the second liquid dispersion comprising the recombination catalyst particles at a wet thickness of approximately 150 μm, then a fourth layer of the same ePTFE with a mass per area of approximately 4 g/m² (used as the microporous polymer structure) was placed on top of the second liquid dispersion and allowed to imbibe (the recombination catalyst particles do not imbibe into the microporous polymer structure and therefore remaining in the layer of ion exchange material forming the recombination catalyst layer, as shown in FIG. 3 discussed below). The composite was then dried first at a temperature of approximately 105° C. for about 2.5 mins and then at a temperature of approximately 150° C. for about 2.5 mins forming a first recombination catalyst layer and a fourth reinforcing layer. This composite was then coated with the second liquid dispersion comprising the recombination catalyst particles at a wet thickness of approximately 90 μm. The composite was then dried first at a temperature of approximately 105° C. for about 2.5 mins and then at a temperature of approximately 150° C. for about 2.5 mins forming a second recombination catalyst layer. The complete multilayer composite was then further heat treated at a temperature of approximately 150° C. for about 5 mins to yield the PEM.

The PEM had the following structure (along with approximate layer thicknesses) starting from the top of the PEM wherein in use, the top layer is intended to be at or closest to an anode side and the bottom layer is intended to be at or closest to a cathode side of an electrolyser PEM electrode assembly: a second recombination catalyst layer (thickness of 5.46 μm) forming an outer surface of the PEM; a fully imbibed fourth reinforcement layer (thickness of 6.45 μm); a first recombination catalyst layer (thickness of 5.06 μm); a fully imbibed third reinforcement layer (thickness of 5.46 μm); a third ion exchange material layer (thickness of 5.46 μm); a second reinforcement layer (thickness of 7.04 μm); a second ion exchange material layer (thickness of 5.85 μm); a first reinforcement layer (thickness of 7.24 μm); and a first ion exchange material layer (thickness of 3.97 μm). The measured total thickness of the PEM was approximately 48 μm at about 50% RH.

The recombination catalyst loadings of the first and the second recombination catalyst layers were as follows:

The first recombination catalyst layer between the third and the fourth reinforcement layers has a catalyst loading of approximately 19 ag/cm² Pt.

The second recombination catalyst layer has a catalyst coating of approximately 11 ag/cm² Pt.

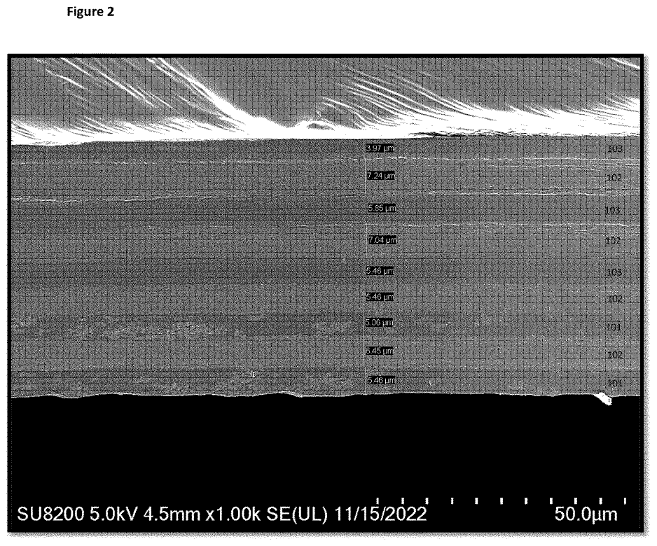

FIG. 1C shows a schematic of the PEM according to Example 1. FIG. 2 shows a cross-sectional SEM (scanning electron microscope image) of the PEM of Example 1, wherein the image of FIG. 2 is inverted with respect to FIG. 1C (i.e. the first recombination catalyst layer 101 is at the bottom layer in the image of FIG. 2). The PEM is a multi-layered membrane, containing nine layers, the respective layer thicknesses are shown in FIG. 2. Reference numeral 101 refers to a recombination catalyst layer. Reference numeral 102 refers to a reinforcing layer. Reference numeral 103 refers to an ion exchange material layer. Reference numeral 200 refers to a backer layer.

FIG. 3 shows another cross-sectional image of the PEM of Example 1, wherein the image of FIG. 3 is inverted with respect to FIG. 1C (i.e. the first recombination catalyst layer 101 is at the bottom layer in the image of FIG. 3). FIG. 3 is a back-scattered electron image to highlight the presence of recombination catalyst particles (shown as white marks 210) in the second recombination catalyst layer 101 and the first recombination catalyst layer 101. No or negligible amounts of recombination catalyst particles were present in all other layers. Accordingly, it can be seen that recombination catalyst layers 101 are separated by reinforcement layer 102 which forms a region devoid of recombination catalyst (no white marks 210 are visible in reinforcing layer 102). Reference numeral 101 refers to a recombination catalyst layer. Reference numeral 102 refers to a reinforcing layer. Reference numeral 103 refers to an ion exchange material layer.

### Example 2 (FIG. 1B)

A first liquid dispersion was prepared to contain 13 wt % solids of a PFSA ionomer blend from Asahi Glass Co., Japan (G701=IW100-700 and G701NPC=IW101-700) in a solvent blend of 34.9 wt % water and 65.1 wt % ethanol (first ion exchange material). The PFSA ionomer IW101-700 contains a cerium additive. The two ionomers were blended to achieve a Ce wt % of 0.0452% in dispersion.

A second liquid dispersion was prepared to contain 13 wt % solids of PFSA ionomer from Asahi Glass Co., Japan (G701=IW100-700) in a solvent blend of 37.8 wt % water and 62.2 wt % ethanol. A mixture was formed from this second liquid dispersion containing platinum (Pt) supported on carbon from N. E. Chemcat Corporation (SA50BK) in a concentration of 0.194 wt % Pt total in the mixture.

A PET backer layer was coated with the first liquid dispersion in a wet thickness of approximately 120 μm, then a first layer of ePTFE with a mass per area of approximately 4 g/m² (used as a microporous polymer structure) was placed on top of the first liquid dispersion and allowed to imbibe. The composite was then dried first at a temperature of approximately 105° C. for about 2.5 mins and then at a temperature of approximately 150° C. for about 2.5 mins forming a first ion exchange material layer and a first reinforcing layer. This composite was then coated with the first liquid dispersion in a wet thickness of approximately 120 μm, then a second layer of the same ePTFE with a mass per area of approximately 4 g/m² (used as a microporous polymer structure) was placed on top of the dispersion and allowed to imbibe. The composite was then dried first at a temperature of approximately 105° C. for about 2.5 mins and then at a temperature of approximately 150° C. for about 2.5 mins forming a second ion exchange material layer and a second reinforcing layer.

The composite was then coated with the mixture of the second liquid dispersion and recombination catalyst particles at a wet thickness of approximately 120 μm, then a third layer of ePTFE with a mass per area of approximately 4 g/m² (used as a microporous polymer structure) was placed on top of the mixture and allowed to imbibe (the recombination catalyst particles do not imbibe into the microporous polymer structure and therefore remaining in the layer of ion exchange material forming the recombination catalyst layer). The composite was then dried first at a temperature of approximately 105° C. for about 2.5 mins and then at a temperature of approximately 150° C. for about 2.5 mins forming a first recombination catalyst layer and a third reinforcing layer. The composite was then coated with the mixture of the second liquid dispersion and recombination catalyst particles at a wet thickness of approximately 70 μm. The composite was then dried first at a temperature of approximately 105° C. for about 2.5 mins and then at a temperature approximately 150° C. for about 2.5 mins forming a second recombination catalyst layer. This complete multilayer composite was then further heat treated at a temperature of approximately 150° C. for about 5 mins to yield the PEM.

The PEM had the following structure (along with approximate layer thicknesses) starting from the top with the last coated layer down to the first coated layer on the backer layer: a second recombination catalyst layer; a third fully imbibed reinforcing layer; a first recombination catalyst layer; a second fully imbibed reinforcing layer; a second ion exchange material layer; a first fully imbibed reinforcing layer; and a first ion exchange material layer. The measured total thickness of the PEM was approximately 38 μm at about 50% RH.

The first and second recombination catalyst layers having recombination catalyst loadings as follows:
The first recombination catalyst layer between the second and the third reinforcing layers, has a catalyst loading of approximately 19 ag/cm² Pt.
The second recombination catalyst layer has a catalyst loading of approximately 11 ag/cm² Pt.

### Comparative Example 1 (FIG. 6A)

A first liquid dispersion was prepared to contain 13 wt % solids of a PFSA ionomer from Asahi Glass Co., Japan (G701=IW100-700) in a solvent blend of 35.1 wt % water and 64.9 wt % ethanol (first ion exchange material). A second liquid dispersion was prepared to contain 13.7% solids of a PFSA ionomer from Asahi Glass Co., Japan (G701=IW100-700) in a solvent blend of 33.2 wt % water and 66.8 wt % ethanol.

A PET backer layer (not visible) was coated with the first liquid dispersion in a wet thickness of approximately 120 μm, then a first layer of ePTFE with a mass per area of approximately 4 g/m² (used as a microporous polymer structure) was placed on top of the first liquid dispersion and allowed to imbibe. The composite was then dried first at a temperature of approximately 105° C. for about 2.5 mins and then at a temperature of approximately 150° C. for about 2.5 mins forming a first ion exchange material layer 403 and a first reinforcing layer 402. This composite was then coated with the first liquid dispersion in a wet thickness of approximately 120 μm, then a second layer of the same ePTFE with a mass per area of approximately 4 g/m² (used as a microporous polymer structure) was placed on top of the dispersion and allowed to imbibe. The composite was then dried first at a temperature of approximately 105° C. for about 2.5 mins and then at a temperature of approximately 150° C. for about 2.5 mins forming a second ion exchange material layer 403 and a second reinforcing layer 402. This composite was then coated with the second liquid dispersion in a wet thickness of approximately 120 μm, then a third layer of the same ePTFE with a mass per area of approximately 4 g/m² (used as a microporous polymer structure) was placed on top of the dispersion and allowed to imbibe. The composite was then dried first at a temperature of approximately 105° C. for about 2.5 mins and then at a temperature of approximately 150° C. for about 2.5 mins forming a third ion exchange material layer 403 and a third reinforcing layer 402. This composite was then coated with the second liquid dispersion in a wet thickness of approximately 70 μm. The composite was then dried first at a temperature of approximately 105° C. for about 2.5 mins and then at a temperature of approximately 150° C. for about 2.5 mins forming a fourth ion exchange material layer 403. The complete multilayer composite was then further heat treated at a temperature of approximately 150° C. for about 5 mins to yield the PEM. The multilayer composite has a thickness of about 38 μm.

### Comparative Example 2 (FIG. 6B)

A first liquid dispersion was prepared to contain 13 wt % solids of a PFSA ionomer blend from Asahi Glass Co., Japan (G701=IW100-700 and G701NPC=IW101-700) in a solvent blend of 35.1 wt % water and 64.9 wt % ethanol (first ion exchange material). A second liquid dispersion was prepared to contain 13.7% solids of a PFSA ionomer from Asahi Glass Co., Japan (G701=IW100-700) in a solvent blend of 33.2 wt % water and 66.8 wt % ethanol.

A third liquid dispersion was prepared to contain 12.2 wt % solids of PFSA ionomer from Asahi Glass Co., Japan (G701=IW100-700) in a solvent blend of 38.7 wt % water and 61.3 wt % ethanol. A mixture was formed from this second liquid dispersion containing platinum (Pt) supported on carbon from N. E. Chemcat Corporation (SA50BK) in a concentration of 0.318 wt % Pt total in the mixture.

A PET backer layer was coated with the first liquid dispersion in a wet thickness of approximately 120 μm, then a first layer of ePTFE with a mass per area of approximately 4 g/m² (used as a microporous polymer structure) was placed on top of the first liquid dispersion and allowed to imbibe. The composite was then dried first at a temperature of approximately 105° C. for about 2.5 mins and then at a temperature of approximately 150° C. for about 2.5 mins forming a first ion exchange material layer 403 and a first reinforcing layer 402. This composite was then coated with the first liquid dispersion in a wet thickness of approximately 120 μm, then a second layer of the same ePTFE with a mass per area of approximately 4 g/m² (used as a microporous polymer structure) was placed on top of the dispersion and allowed to imbibe. The composite was then dried first at a temperature of approximately 105° C. for about 2.5 mins and then at a temperature of approximately 150° C. for about 2.5 mins forming a second ion exchange material layer 403 and a second reinforcing layer 402. This composite was then coated with the second liquid dispersion in a wet thickness of approximately 120 μm, then a third layer of the same ePTFE with a mass per area of approximately 4 g/m² (used as a microporous polymer structure) was placed on top of the dispersion and allowed to imbibe. The composite was then dried first at a temperature of approximately 110° C. for about 2.5 mins and then at a temperature of approximately 150° C. for about 2.5 mins forming a third ion exchange material layer 403 and a third reinforcing layer 402.

The composite was then coated with the mixture of the third liquid dispersion and recombination catalyst particles at a wet thickness of approximately 70 μm. The composite was then dried first at a temperature of approximately 110° C. for about 2.5 mins and then at a temperature approximately 150° C. for about 2.5 mins forming a first recombination catalyst layer 401. This complete multilayer composite was then further heat treated at a temperature of approximately 150° C. for about 5 mins to yield the PEM 400. The first recombination catalyst layer 401 has a catalyst loading of approximately 18 ag/cm² Pt.

A cross-sectional SEM of PEM 400 of comparative example 2 is shown in FIG. 6C. Starting from the top as the last coated layer down to the first coated layer on the backer layer (not shown), the PEM 400 comprises: a first recombination catalyst layer 401 (thickness of 3.97 μm); a third reinforcing layer 402 (thickness of 6.60 μm); a third ion exchange material layer 403 (thickness of 5.51 μm); a second reinforcing layer (thickness of 7.24 μm) I a second ion exchange material layer 403 (thickness of 5.95 μm); a first reinforcing layer 402 (thickness of 6.25 am); and a first ion exchange material layer 403 (thickness of 5.06 μm), wherein the thickness is measured at about 50% RH. FIG. 6D shows a cross-sectional back-scattered image of the PEM 400 of comparative example 2, wherein the recombination catalyst particles are denoted by reference number 410 and are only present in first recombination catalyst layer 401.

### Example 3 (FIG. 4A)

Another example of PEM 300 is shown in FIG. 4A. The method of constructing the PEM 300 is the same as the process outlined above with respect to examples 1 and 2.

A first liquid dispersion was prepared to contain 15 wt % solids of a PFSA ionomer blend from Asahi Glass Co., Japan—(G701=IW100-700 and G701NPC=IW101-700) in a solvent blend of 40.0 wt % water and 60.0 wt % ethanol (first ion exchange material). The PFSA ionomer G701NPC contains a cerium additive. The two ionomers were blended to achieve a Ce wt % of 0.039% in dispersion.

A second liquid dispersion was prepared to contain 15 wt % solids of PFSA ionomer from Asahi Glass Co., Japan (G701=IW100-700) in a solvent blend of 40.0 wt % water and 60.0 wt % ethanol. A mixture was formed from this second liquid dispersion containing platinum (Pt) supported on carbon from N. E. Chemcat Corporation (SA50BK) in a concentration of 0.371 wt % Pt total in the mixture.

A PET backer layer was coated with the second_liquid dispersion and recombination catalyst particles at a wet thickness of approximately 110 μm, then a first layer of ePTFE with a mass per area of approximately 4 g/m2 (used as a microporous polymer structure) was placed on top of the second liquid dispersion and allowed to imbibe (the recombination catalyst particles do not imbibe into the microporous polymer structure and therefore remaining in the layer of ion exchange material forming the recombination catalyst layer). The composite was then dried first at a temperature of approximately 140° C. for about 1 min and then at a temperature of approximately 170° C. for about 2 mins forming a first recombination catalyst layer and a first ion exchange material layer and a first reinforcing layer.

This composite was then coated with the first liquid dispersion in a wet thickness of approximately 110 μm, then a second layer of the ePTFE with a mass per area of approximately 4 g/m2 (used as a microporous polymer structure) was placed on top of the dispersion and allowed to imbibe. The composite was then dried first at a temperature of approximately 140° C. for about 1 min and then at a temperature of approximately 170° C. for about 2 mins forming a second ion exchange material layer and a second reinforcing layer.

The composite was then coated with the mixture of the first liquid dispersion at a wet thickness of approximately 110 μm, then a third layer of the ePTFE with a mass per area of approximately 4 g/m2 (used as a microporous polymer structure) was placed on top of the mixture and allowed to imbibe. The composite was then dried first at a temperature of approximately 140° C. for about 1 min and then at a temperature of approximately 170° C. for about 2 mins forming a third reinforcing layer.

The composite was then coated with the mixture of the second liquid dispersion and recombination catalyst particles at a wet thickness of approximately 65 μm. The composite was then dried first at a temperature of approximately 140° C. for about 1 min and then at a temperature approximately 170° C. for about 2 mins forming a second recombination catalyst layer. This complete multilayer composite was then further heat treated at a temperature of approximately 160° C. for about 6 mins to yield the PEM.

The PEM had the following structure (along with approximate layer thicknesses as measured by the SEM image shown in FIG. 5A) starting from the top with the last coated layer down to the first coated layer on the backer layer: a second recombination catalyst layer 301 (thickness of 4.76 μm); a third fully imbibed reinforcing layer 302 (thickness of 6.20 μm); a second ion exchange material layer 303 (thickness of 4.02 μm); a second fully imbibed reinforcing layer 302 (thickness of 5.85 μm); an first ion exchange material layer 303 (thickness of 4.32 μm); a first fully imbibed reinforcing layer 402 (thickness of 6.70 μm); and a first recombination catalyst layer 301 (thickness of 4.91 μm). The measured total thickness of the PEM was approximately 38 μm at about 50% RH.

The first and second recombination catalyst layers having recombination catalyst loadings were as follows:

The first recombination catalyst layer has a catalyst loading of: approximately 18 ag/cm² Pt.

The second recombination catalyst layer surface layer has a catalyst loading of: approximately 11 ag/cm² Pt.

The distance from the first recombination catalyst layer (i) to the anode is 0 μm, and the distance from the second recombination catalyst layer (vii) to the cathode is 0 μm.

Both recombination catalyst layers comprise anti-oxidant additives, e.g. a cerium additive (153 mg/m²) and ion exchange material.

The recombination catalyst layer near the anode side targets lowering H₂ in O₂ explosive mixture. The recombination catalyst layer near the cathode side targets lowering O₂ in H₂ for H₂ purity. The distance away from each side can be selected to tune efficiency given anode and cathode pressure and therefore partial pressures of O₂ and H₂ in the thickness of the PEM.

FIG. 5B shows another cross-sectional image of the PEM of Example 3. FIG. 5B is a back-scattered electron image to highlight the presence of recombination catalyst particles (shown as white marks 310) in the second recombination catalyst layer 301 and the first recombination catalyst layer 301. No or negligible amounts of recombination catalyst particles were present in all other layers. Accordingly, it can be seen that recombination catalyst layers 301 are separated by reinforcing layers 302 and ion exchange material layers 303 which forms a region devoid of recombination catalyst (no white marks 310 are visible in reinforcing layers 302 and ion exchange material layers 303).

### Results and Analysis

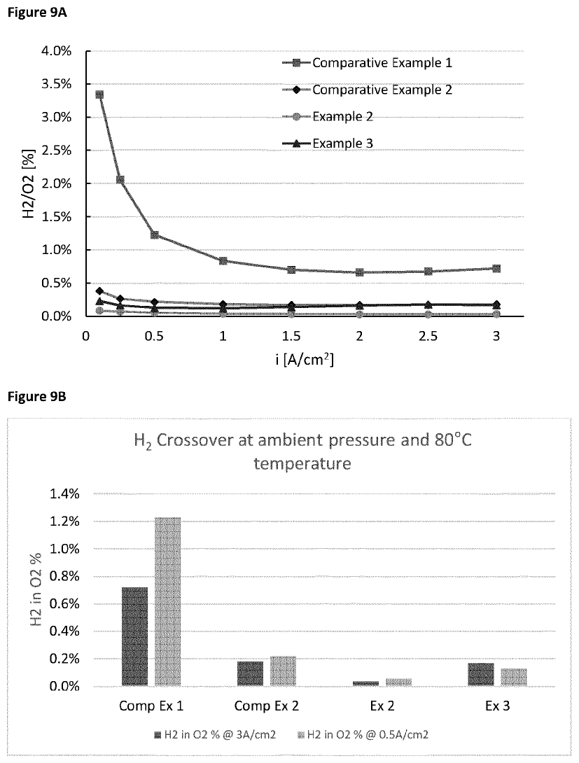

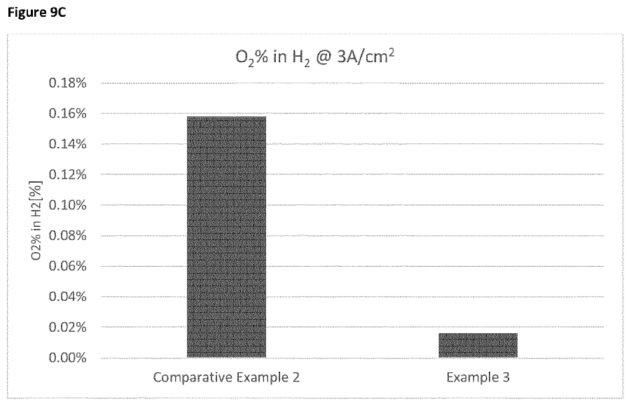

FIG. 9A shows a plot of hydrogen crossover according to electric current density for the PEMs of examples 2, 3 and comparative examples 1 and 2, when used in an electrolyzer. FIG. 9B shows a chart of hydrogen crossover according to electric current density for the PEMs of examples 2, 3 and comparative examples 1 and 2, when used in an electrolyzer. The H₂ in O₂ concentrations in comparative example 1 are indicative of the unmitigated hydrogen flux through a PEM with the construction containing three reinforcement layers and four ion exchange layers of those thicknesses and specific materials of construction in this electrolyzer system. The data for comparative example 2 shows the reduction in H₂ in O₂ concentration through the addition of a single recombination catalyst layer 401 positioned near the anode. The significant further reduction in H₂ in O₂ at high (3 A/cm²) and low current (0.5 A/cm²) density regimes in Example 2 is achieved by incorporating a first and second recombination catalyst layer, where the first is positioned closer to the middle of the thickness of the PEM compared to the second recombination layer (see, FIG. 1B). For the specific electrolyzer cell and system design and operating conditions at ambient pressure, the first recombination layer may be closer to an optimally efficient location compared to the second recombination layer nearer to the anode. This enabled the observed extreme 96% reduction in H₂ in O₂ at 0.5 A/cm² and 95% reduction at 3 A/cm² compared to comparative example 1. Even though a similar total loading of Pt recombination catalyst is present in example 3 and example 2, example 3 shows less effectiveness at reducing H₂ in O₂ concentration for this electrolyzer system given the cathode facing and anode facing positions of the two recombination catalyst layers. There was lower benefit from two recombination catalyst layers for H₂ in O₂ reduction in example 3 vs example 2 when compared to the effectiveness of a single recombination catalyst layer in comparative example 2.

FIG. 9C shows a chart of oxygen crossover at an electric current density of 3 A/cm² for the PEMs of example 3 and comparative example 2, when used in an electrolyzer. FIG. 9C demonstrates the significant value of a second recombination catalyst layer located near the cathode in reducing O₂ in H₂ concentration. Interestingly, when comparing the recombination efficiency of example 3 vs comparative example 2, the O₂ in H₂ is reduced by about 90% at 3 A/cm² whereas the H₂ in O₂ discussed previously is reduced by about 7% at 3A/cm² and about 41% at 0.5 A/cm². This further demonstrates that the recombination catalyst layer positions can be optimized for H₂ in O₂ reduction as shown in example 2 or O₂ in H₂ reduction as shown in example 3 and these strategies can be utilized to reduce both with further embodiments.

It can be seen that by incorporating multiple recombination catalyst layers at optimum locations and loadings in a given PEM design and an electrolyzer design and operating conditions, significant reductions in H₂ in O₂ and O₂ in H₂ can be achieved. As previously discussed, this can help to enable multiple techniques for lowering production costs associated with PEM water electrolysis including (i) improving the efficiency of PEM water electrolysis through enabling lower resistance PEM designs as well as (ii) increasing the pressure of hydrogen to reduce downstream compression costs, (iii) extending the range of electrolyzer operations to very low load range to maximise utilization of renewable energy sources, and (iv) extending the operational lifetime of the electrolyzer and (v) decreasing capital and maintenance costs of hydrogen purification units by increasing purity level of produced hydrogen directly in the electrolysis cell, reducing the need of additional purification processes all through more efficient and durable recombination effectiveness.

As shown, the invention discussed here can uniquely enable more efficient recombination catalyst effectiveness. It can also be hypothesized that the design in example 2 compared to comparative example 1 is not only more effective at reducing H₂ in O₂ initially for the system used in this testing, but would be more likely to have better efficiency for H₂ in O₂ reduction in other system designs and operating conditions. It could also retain efficiency when H2 permeation increases over time caused by supersaturation from system degradation.

All ranges described herein are exemplary in nature and include any and all values in between. The terms “approximately” and “about” used herein are interchangeable and refer to a measurement that includes the stated measurement and any measurements reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine. In the event it is determined that individuals having ordinary skill in the relevant arts would not readily ascertain values for such reasonably small differences, the terms “about” and “approximately” can be understood to mean plus or minus 10% of the stated value.

Throughout the description and claims, the terms take the meanings explicitly defined herein, unless the context clearly dictates otherwise.

The phrases “in one embodiment”, “in an embodiment” and “in some embodiments” etc. as used herein do not necessarily refer to the same embodiment(s), though they may. Furthermore, the phrases “in another embodiment” and “in some other embodiments” as used herein do not necessarily refer to a different embodiment, though they may. All embodiments of the disclosure are intended to be combinable.

The terms “comprises” and “comprising” mean to include but not limited to, such that further features may be present. The terms may also mean to consist of.

All references and test methods cited herein are incorporated by reference in their entireties.

1. A multi-layered proton exchange membrane for water electrolysis, comprising:
(i) at least two recombination catalyst layers, each of the at least two recombination catalyst layers comprising a recombination catalyst and a first ion exchange material, wherein at least two recombination catalyst layers are separated by a region devoid of or substantially devoid of a recombination catalyst, and
(ii) at least two reinforcing layers, each of the at least two reinforcing layers comprising a microporous polymer structure and a second ion exchange material which is at least partially imbibed within the microporous polymer structure.

2. The multi-layered proton exchange membrane of claim 1, wherein the region separating at least two recombination catalyst layers has a thickness of at least about 1 μm at 50% relative humidity (RH).

3. (canceled)

4. The multi-layered proton exchange membrane of claim 1, wherein the recombination catalyst comprises one or more selected from a group consisting of platinum, palladium, iridium, rhodium, ruthenium, osmium, nickel, cobalt, titanium, tin, tantalum, niobium, antimony, lead, manganese, and an oxide thereof.

5. (canceled)

6. (canceled)

7. (canceled)

8. (canceled)

9. (canceled)

10. (canceled)

11. The multi-layered proton exchange membrane of claim 1, wherein each of the at least two recombination catalyst layers has a minimum thickness at 50% RH of about 1 μm.

12. The multi-layered proton exchange membrane of claim 1, wherein the recombination catalyst is present in each of the at least two recombination catalyst layers at a loading of up to about 0.10 mg/cm².

13. (canceled)

14. (canceled)

15. (canceled)

16. The multi-layered proton exchange membrane of claim 1, comprising a total of four recombination catalyst layers.

17. The multi-layered proton exchange membrane of claim 1, further comprising an ion exchange material layer comprising a third ion exchange material, wherein the ion exchange material layer is devoid of or substantially devoid of a microporous polymer structure and a recombination catalyst.

18. (canceled)

19. (canceled)

20. The multi-layered proton exchange membrane of claim 1, wherein the recombination catalyst of each of the at least two recombination catalyst layers is dispersed in the first ion exchange material.

21. (canceled)

22. The multi-layered proton exchange membrane of claim 1, wherein the first ion exchange material and second ion exchange material each comprises a proton conducting polymer selected from a group consisting of a hydrocarbon ionomer, a perfluorinated ionomer, and perfluorosulfonic acid ionomer.

23. The multi-layered proton exchange membrane of claim 17, wherein the region separating at least two recombination catalyst layers comprises the ion exchange material layer.

24. The multi-layered proton exchange membrane of claim 1, wherein the region separating at least two recombination catalyst layers comprises at least one reinforcing layer.

25. The multi-layered proton exchange membrane of claim 1, wherein the second ion exchange material which is at least partially imbibed within the microporous polymer structure renders the microporous polymer structure occlusive.

26. The multi-layered proton exchange membrane of claim 1, wherein the microporous polymer structure is fully imbibed with the second ion exchange material.

27. The multi-layered proton exchange membrane of claim 1, wherein the total content of the microporous polymer structure in the multi-layered proton exchange membrane is at least about 1 g/m² based upon the total area of the multi-layered proton exchange membrane.

28. (canceled)

29. A multi-layered proton exchange membrane of claim 1, wherein the microporous polymer structure of each of the at least two reinforcing layers comprises at least one fluorinated polymer.

30. (canceled)

31. (canceled)

32. The multi-layered proton exchange membrane of claim 1, wherein the microporous polymer structure of each of the at least two reinforcing layers comprises a hydrocarbon polymer.

33. (canceled)

34. (canceled)

35. (canceled)

36. The multi-layered proton exchange membrane of claim 1, comprising at least the following layers in the order:
a recombination catalyst layer;
a reinforcing layer;
a recombination catalyst layer;
a reinforcing layer,
wherein the reinforcing layers are devoid of or substantially devoid of a recombination catalyst, and the recombination catalyst layers are devoid of or substantially devoid of a microporous polymer structure.

37. (canceled)

38. The multi-layered proton exchange membrane of claim 1, comprising at least the following layers in the order:
a reinforcing layer:
a recombination catalyst layer;
an ion exchange material layer;
a recombination catalyst layer;
a reinforcing layer,
wherein the reinforcing layers are devoid of or substantially devoid of a recombination catalyst, the recombination catalyst layers are devoid of or substantially devoid of a microporous polymer structure, and the ion exchange material layer is devoid of or substantially devoid of a microporous polymer structure and a recombination catalyst.

39. (canceled)

40. (canceled)

41. (canceled)

42. (canceled)

43. (canceled)

44. A method of manufacturing the multi-layered proton exchange membrane of claim 1, the method comprising the step of:
forming at least two reinforcing layers, and at least two recombination catalyst layers, in any order, with the proviso that the resulting multi-layered proton exchange membrane comprises at least two recombination catalyst layers which are separated by a region devoid of or substantially devoid of a recombination catalyst, wherein the method comprises forming at least one of the at least two recombination catalyst layers by depositing a dispersion comprising ion exchange material and recombination catalyst particles or aggregates onto at least one of the at least two reinforcing layers comprising a microporous polymer structure, and
wherein the microporous polymer structure is configured to prevent recombination catalyst particles or aggregates from impregnating into the pores of the microporous polymer structure.

45. (canceled)

46. (canceled)

47. (canceled)

48. The method of claim 44, wherein the microporous polymer structure is at least partially imbibed with the ion exchange material to form the at least one reinforcing layer; and the recombination catalyst layer is formed from a dispersion of recombination catalyst which has not imbibed into the microporous polymer structure, and
wherein the at least one reinforcing layer at least partially forms the region devoid of, or substantially devoid of recombination catalyst.
